(19) United States
(12) Patent Application Publication
(10) Pub. No.: US 2026/0073248 A1
(43) Pub. Date: Mar. 12, 2026

(54) ARTIFICIAL-INTELLIGENCE-ENHANCED BIAS RESPONSE PROTOCOLS

(71) Applicant: Yainvest Inc., ZUG (CH)

(72) Inventors: Iuliia MYRONOVA, Zug (CH); Enrico De GIORGI, Bellinzona (CH)

(73) Assignee: Yainvest Inc., ZUG (CH)

(21) Appl. No.: 19/219,914

(22) Filed: Jun. 13, 2025

Related U.S. Application Data
(60) Provisional application No. 63/693,247, filed on Sep. 11, 2024.

(51) Int. Cl. G06N 5/022

(52) U.S. Cl. CPC G06N 5/022

(57) ABSTRACT

Bias response methods, systems, and computer program products for detecting and responding to behavioral biases in user plans. A method may include receiving a plan on behalf of a user, calculating an estimated net consequence (ENC) of the plan using machine learning models trained on historical data, and comparing the plan against bias patterns to determine if the plan has recognizable biases. The method may also include generating notifications or tracking user responses to refine response protocols or establish new bias patterns. A system may implement AI enhancement protocols to improve bias detection, analysis, or response capabilities. The system may refine logical bases for plans through user interactions, monitor actual outcomes over time, adjust estimation protocols based on discrepancies between estimated and actual consequences, or improve a bias filter with more or better bias pattern definition.

### RELATED APPLICATIONS

This application claims priority to U.S. Prov. Pat. App. No. 63/693,247 (“Method for Managing Investment Advisory Processes by Predicting Behavioral Biases and Proactively Enhancing Unbiased Investment Decisions”) filed on 11 Sep. 2024, which is incorporated by reference herein to the extent not inconsistent herewith.

### FIELD OF INVENTION

The present disclosure relates generally to systems and methods for detecting and responding to behavioral biases in decision-making processes. More specifically the disclosure pertains to artificial intelligence-enhanced protocols for identifying and responding to cognitive biases in user plans and actions.

### BACKGROUND

Decision-making processes in various domains, including but not limited to finance, healthcare, and business, may be influenced by cognitive biases that can lead to suboptimal outcomes. These biases, which are systematic patterns of deviation from norm or rationality in judgment, may arise from various sources such as information processing shortcuts, emotional and moral motivations, or social influence.

Traditional approaches to addressing cognitive biases have often relied on human expertise and manual intervention. However, these methods may be limited in their ability to detect and respond to biases in real-time, especially when dealing with large volumes of data or complex decision scenarios. Additionally, human experts may themselves be subject to biases, potentially compromising the effectiveness of their interventions.

In recent years, advancements in artificial intelligence (AI) and machine learning technologies have opened up new possibilities for enhancing bias detection and response capabilities. AI-driven systems may be capable of processing vast amounts of data, identifying subtle patterns, and generating insights that may not be immediately apparent to human observers. These systems may also adapt and improve their performance over time through continuous learning from new data and feedback.

However, the development and implementation of AI-enhanced bias response protocols present several challenges. These may include ensuring the accuracy and reliability of bias detection algorithms, maintaining transparency and explainability in AI-driven decision processes, and addressing potential ethical concerns related to the use of AI in influencing human decision-making.

Furthermore, the dynamic nature of human behavior and the evolving landscape of cognitive biases necessitate ongoing refinement and adaptation of bias response protocols. This may involve incorporating new research findings on cognitive biases, updating machine learning models with relevant data, and adjusting intervention strategies based on observed outcomes.

There is a need for comprehensive systems and methods that can leverage the power of artificial intelligence to enhance bias detection and response capabilities while addressing the associated challenges and complexities. Such systems may potentially improve decision-making processes across various domains by mitigating the impact of cognitive biases and promoting more rational and effective choices.

### BRIEF DESCRIPTION OF THE DRAWINGS

FIG. 1 depicts a block diagram showing the system's components for processing state and expression inputs through multiple determinant elements, including ruminant and expedient determinants, to analyze decision-making processes in which one or more improved technologies may be incorporated.

FIG. 2 presents a block diagram of a resource manager connected to plan and decision components, with trigger, condition, and intervention elements for evaluating and responding to plans in which one or more improved technologies may be incorporated.

FIG. 3 shows a network diagram connecting multiple user devices to functional blocks containing various components for bias detection and response protocols in which one or more improved technologies may be incorporated.

FIG. 4 illustrates a system with software-implemented protocols and multiple functional components for processing and analyzing behavioral patterns and biases in which one or more improved technologies may be incorporated.

FIG. 5 displays a block diagram of an apparatus module with action elements, detection and result modules, and a filter component, alongside grouped processing elements and a data region in which one or more improved technologies may be incorporated.

FIG. 6 presents a block diagram showing interconnections between feedback, condition, prediction, model, transmission, context, and outcome components in which one or more improved technologies may be incorporated.

FIG. 7 depicts a server including communication interfaces, processor, storage, and specialized circuitry for AI-enhanced bias analysis in which one or more improved technologies may be incorporated.

FIG. 8 depicts a client device with components for pattern recognition, sequencing logic, and communication interfaces for bias response functionality in which one or more improved technologies may be incorporated.

FIG. 9 presents a flowchart detailing a bias response process, including steps for evaluating plans, identifying biases, and refining protocols based on scrutiny and explanations in which one or more improved technologies may be incorporated.

### DETAILED DESCRIPTION

The detailed description that follows is represented largely in terms of processes and symbolic representations of operations by conventional computer components, including a processor, memory storage devices for the processor, connected display devices, and input devices. Furthermore, some of these processes and operations may utilize conventional computer components in a heterogeneous distributed computing environment, including remote file servers, computer servers, and memory storage devices.

It is intended that the terminology used in the description presented below be interpreted in its broadest reasonable manner, even though it is being used in conjunction with a detailed description of certain example embodiments. Although certain terms may be emphasized below, any terminology intended to be interpreted in any restricted manner will be overtly and specifically defined as such.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

“Above,” “actual,” “adjusted,” “AI-derived,” “at least,” “bias-indicative,” “based on,” “calculated,” “computer-implemented,” “confidence-indicative,” “custom,” “durable,” “economic-theory-based,” “estimated,” “evidence-based,” “first,” “future,” “generic,” “guided,” “improved,” “machine-learning-based,” “natural,” “net,” “non-transitory,” “optimal,” “particular,” “partly,” “pendent,” “predetermined,” “prior,” “ruminant,” “second,” “several,” “specific,” “speculative,” “theory-based,” “third,” “transistor-based,” “unfavorable,” “updated,” “urgent” “weighted,” “wherein,” or other such descriptors herein are used in their normal yes-or-no sense, not merely as terms of degree, unless context dictates otherwise. In light of the present disclosure, those skilled in the art will understand from context what is meant by “remote” and by other such positional descriptors used herein. Likewise, they will understand what is meant by “partly based” or other such descriptions of dependent computational variables/signals. “Numerous” as used herein refers to more than 50. “Immediate” as used herein refers to having a duration of less than 60 seconds unless context dictates otherwise. Circuitry is “invoked” as used herein if it is called on to undergo voltage state transitions so that digital signals are transmitted therefrom or therethrough unless context dictates otherwise. Software is “invoked” as used herein if it is executed/triggered unless context dictates otherwise. Digital information may be “obtained” as described herein by generating it or receiving it via various circuitry described herein, for example, or by inferring it from a person who has apparently decided not to take an available action. One number is “on the order” of another if they differ by less than an order of magnitude (i.e., by less than a factor of ten) unless context dictates otherwise. As used herein “causing” is not limited to a proximate cause but also enabling, conjoining, or other actual causes of an event or phenomenon. “Instances” of an item may or may not be identical or similar to each other, as used herein.

Terms like “processor,” “center,” “unit,” “computer,” or other such descriptors herein are used in their normal sense, in reference to an inanimate structure. Such terms do not include any people, irrespective of their location or employment or other association with the thing described, unless context dictates otherwise. “For” is not used to articulate a mere intended purpose in phrases like “circuitry for” or “instruction for,” moreover, but is used normally, in descriptively identifying special purpose software or structures.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

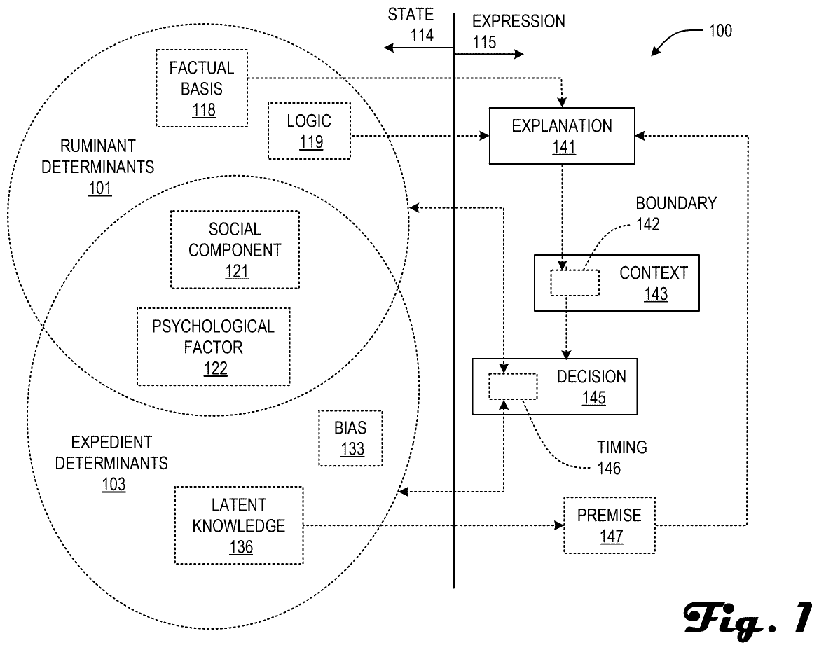

Referring now to FIG. 1 there is shown a block diagram 100 that typifies a relationship between a psychological state 114 of one or more users with one or more digital expressions 115 manifested in hardware. As shown a psychological state 114 may include one or more instances of factual bases 113, of logic 119, of social components 121, of psychological factors 122, of biases 133, of latent knowledge 136, or of other human elements (e.g. pertaining to plans and preferences of a given user as described below). It deserves emphasis that some of these are deemed “ruminant” determinants 101, referring to those primarily relied on in deliberate analyses. These can be contrasted with “expedient” determinants 103 as shown, those used in fast decisions 145.

In some contexts in which a fast decision 145 relies upon one or more social components 121 or psychological factors 122 (or both), the decision 145 may also signal a reliance on bias 133 or latent knowledge 136 that each create opportunities for improved decision-making. Expedient decisions 145 are often correct, even when they are not reliable or meritorious, creating difficulty in separating which determinants 101, 103 were pivotal any given occasion. Moreover the timing 146 of such a decision 145 or its underlying rationales may be critical to its effectiveness, such as when time is of the essence.

Such risks of bias 133 are also problematic in a context 143 in which an outcome of a decision 145 obfuscates a hidden premise 147 by which an expert decision maker reached a rapid decision 145 and in which a well-timed and well-crafted question directed to the decision maker is the only effective protection against hindsight bias 133. A correct decision 145 by an expert can be developed into one or more authentic premises 147 and corresponding explanations 141 that are then optimized by artificial intelligence (“AI”) configured to generate an effectively definable bias “pattern” or other iteratively refined boundary 142 that can be recognized as further described below.

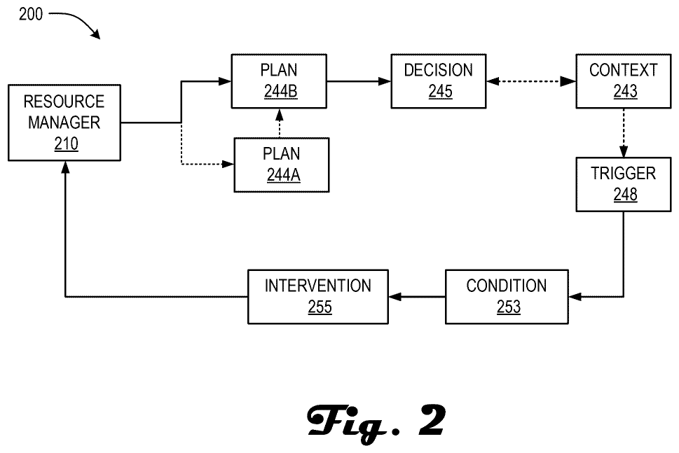

Referring now to FIG. 2 there is shown another block diagram 200 that can overlap or exemplify that of FIG. 1, also indicating relationships among contexts 143, 243 and decisions 145, 245. As shown a resource manager 210 has indicated a preliminary first plan 244A that may manifest one or more biases 133 or have other flaws that can hopefully be recognized and addressed before an ensuing decision 245. Where feasible one or more triggers 248 may be established, for example, so that when a defined condition 253 is detected a recommendation, mitigation, or other intervention 255 is proposed in real time (e.g. less than one minute after detecting the condition 253). The condition 253 may be a news item ingestion, a periodic maintenance protocol, a resource depletion crossing a corresponding boundary 142, or a risk exceeding a threshold associated with a client. In some variants the type 385 of or size of the intervention 255 may depend on a (nominally apparent) bias 133 and a confidence level that harm from the bias 133 may exceed a corresponding threshold. And a timely response of the resource manager (e.g. adopting a more vetted plan 244B that mitigates at least some of the first plan 244A) may trigger a quantifiably better decision 245 by estimating a net consequence before and after the resource manager 210 changed course.

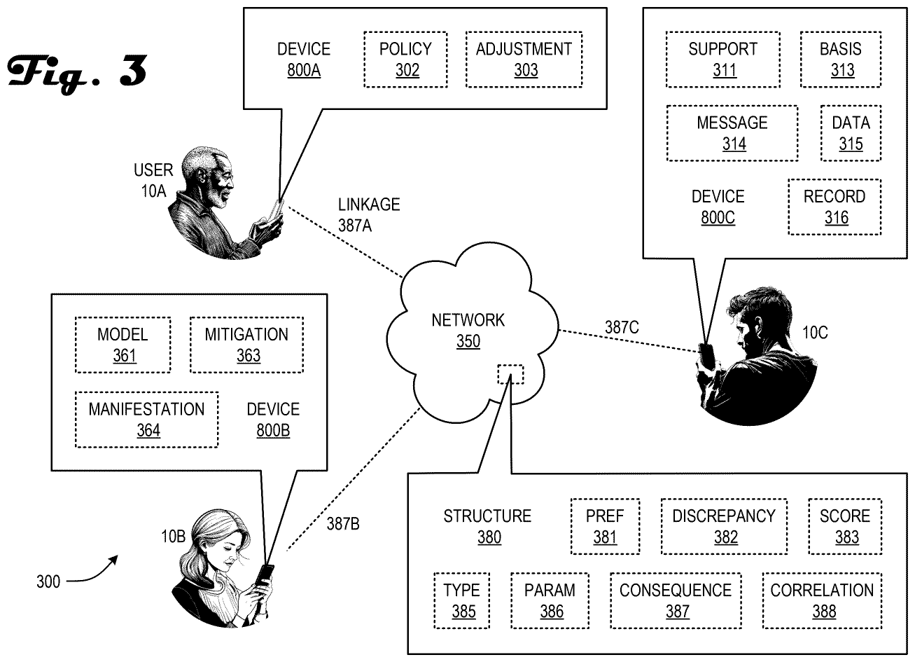

Referring now to FIG. 3 there is shown a system 300 in which one or both of the above-referenced block diagrams 100, 200 may be implemented. As shown a first device 800A observed by a first user 10A may handle one or more instances of policies 302 or of adjustments 303 and may interact remotely via linkage 387A with network 350 and devices 800B-C. Likewise a second device 800B (at least intermittently) observed by a second user 10B may handle one or more instances of models 361, of mitigations 363, and of manifestations 364 and may interact via linkage 387B with network 350 and devices 800A, 800C. Likewise a third device 800C observed by a third user 10C may handle one or more instances of support 311, of logical bases 313, of messages 314, of data 315, or of records 316 and may interact via linkage 387C with network 350 or devices 800A-B (or both).

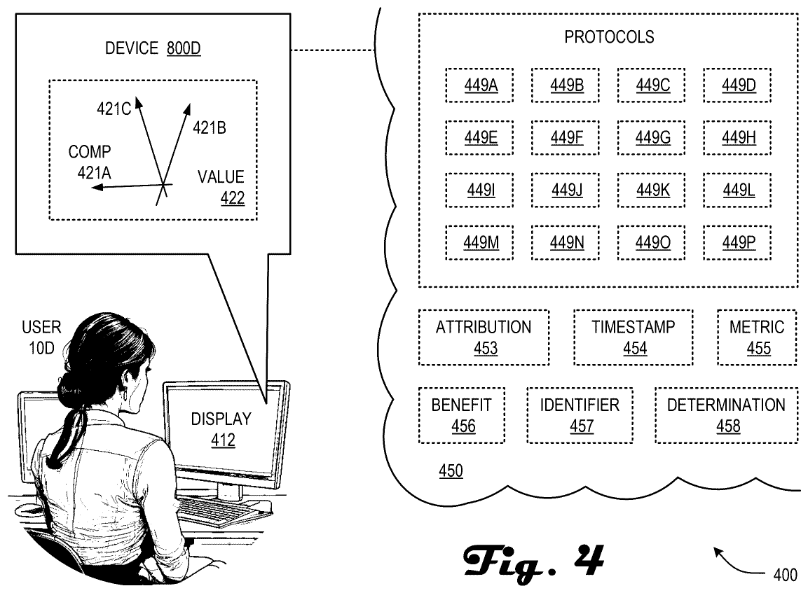

Referring now to FIG. 4 there is shown a system 400 in which a client device 800D presents one or more quantified components 421A-C of each plan 244, consequence 387, or other value 422 described herein to a user 10D via one or more displays 412. One or more such devices 800A-D are operably coupled with device-executable code or other digital structures 380 residing in or available through one or more networks 350, 450 described herein. Such code may include numerous instances protocols 449A-P as well as instances of attributions 453, of timestamps 454, of performance metrics 455 (e.g. of scores 383 or other net consequences 387), of benefits 456, of identifiers 457, or of determinations 458 as further described below.

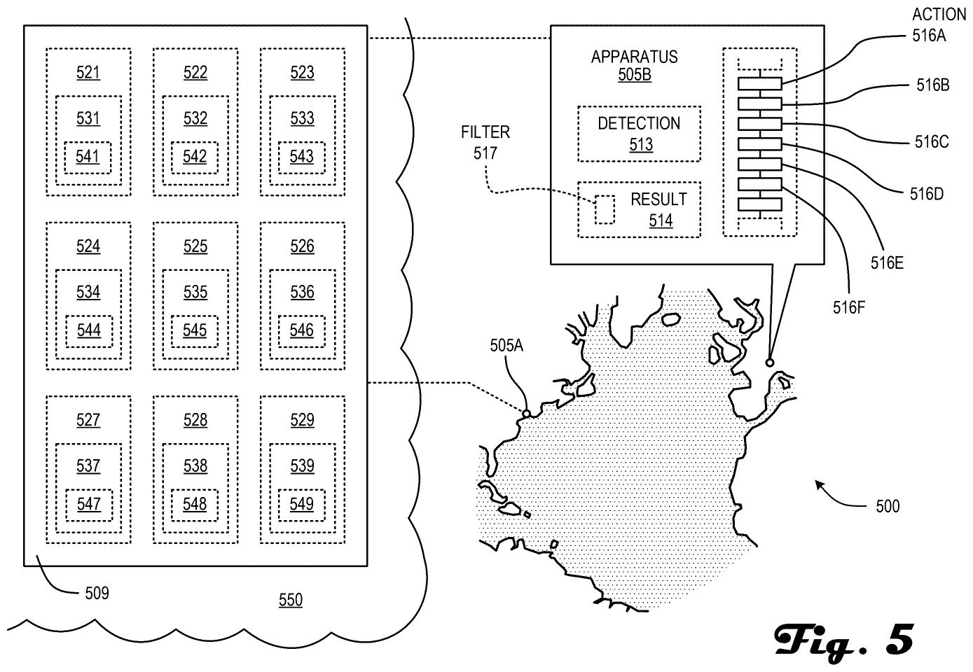

Referring now to FIG. 5 there is shown a system 500 by which one or more apparatuses 505A in North America can work in conjunction with one or more apparatuses 505B in Europe. A bias filter 517 is applied to a newly encountered plan 244. If a result 514 indicates that a bias 133 is recognized and an ENC 387 signals unfavorably (e.g. excessive risk or expense), a user 10 may receive a warning about the unfavorable prediction and may be prompted for an override or clear explanation 141 even before being allowed to proceed with the plan 244. If the pattern is recurrent but is not yet recognized as a bias 133, the system may respond by establishing or proposing a new bias pattern or bias exception pattern. A plan 244A may be acted upon, for example, based on a weighted sum as a score 383 to be categorized in ranges. In some variants the score 383 may reflect a determination 458 whether or not a suitable pendent explanation 141 has been provided (e.g. by AI or a proponent user 10A); a current reputation score 383 of the AI or proponent user 10A; a quantification of how small or reversible the initial step of the plan 244 is; a risk tolerance or other preferences 381 of one or more stakeholder users 10B-D; or other such parameters 386. This can occur, for example, in a context in which a pattern of oblivious and chronic harmful belief and behavior would otherwise continue unprevented.

In the interest of concision and according to standard usage in information management technologies, the functional attributes of modules described herein are set forth in natural language expressions. It will be understood by those skilled in the art that such expressions (functions or acts recited in English, e.g.) adequately describe structures identified below so that no undue experimentation will be required for their implementation. For example, any session metadata or other informational data identified herein may be represented digitally as a voltage configuration on one or more electrical nodes (conductive pads of an integrated circuit, e.g.) of an event-sequencing structure without any undue experimentation. Each electrical node is highly conductive, having a corresponding nominal voltage level that is spatially uniform generally throughout the node (within a device or local system as described herein, e.g.) at relevant times (at clock transitions, e.g.). Such nodes (lines on an integrated circuit or circuit board, e.g.) may each comprise a forked or other signal path adjacent one or more transistors. Moreover, many Boolean values (yes-or-no decisions, e.g.) may each be manifested as either a “low” or “high” voltage, for example, according to a complementary metal-oxide-semiconductor (CMOS), emitter-coupled logic (ECL), or other common semiconductor configuration protocol. In some contexts, for example, one skilled in the art will recognize an “electrical node set” as used herein in reference to one or more electrically conductive nodes upon which a voltage configuration (of one voltage at each node, for example, with each voltage characterized as either high or low) manifests a yes/no decision 145, 245 or other digital data 315.

Referring now to FIG. 5, such circuitry 509 may comprise one or more integrated circuits (ICs) in a network 550, for example, optionally mounted on one or more circuit boards that implementing an event-sequencing structure as generally described in U.S. Pat. Pub. No. 2015/0094046 but configured as described herein. Transistor-based circuitry 509 may (optionally) include one or more instances of aggregation modules 521 configured for cloud-based or other remote processing, for example, (each) including an electrical node set 531 upon which plans 244, predictions, policies 302, and other informational data 315 are represented digitally as a corresponding voltage configuration 541. Transistor-based circuitry 509 may likewise include one or more instances of control modules 522 configured for cloud-based or other remote processing, for example, including an electrical node set 532 upon which event sequencing and related data 315 are represented digitally as a corresponding voltage configuration 542. Transistor-based circuitry 509 may likewise include one or more instances of decision modules 523 configured for cloud-based or other remote processing, for example, including an electrical node set 533 upon which determinations 458 and related data 315 are represented digitally as a corresponding voltage configuration 543. Transistor-based circuitry 509 may (optionally) likewise include one or more instances of response modules 524 configured for triggering remote processing (using cloud-based instances of circuitry described herein, for example), including an electrical node set 534 upon which an invocable subroutine's address or other informational data 315 is represented digitally as a corresponding voltage configuration 544. Transistor-based circuitry 509 may likewise include one or more instances of machine learning modules 525, for example, including an electrical node set 535 upon which queries, feedback, and related data 315 are represented digitally as a corresponding voltage configuration 545. Transistor-based circuitry 509 may likewise include one or more instances of interface modules 526 configured for cloud-based or other remote processing, for example, including an electrical node set 536 upon which a neural network or other useful structure 380 is represented digitally as a corresponding voltage configuration 546. Transistor-based circuitry 509 may likewise include one or more instances of generative modules 527 configured for cloud-based or other remote processing, for example, including an electrical node set 537 upon which informational data 315 is represented digitally as a corresponding voltage configuration 547. Transistor-based circuitry 509 may likewise include one or more instances of distillation modules 528 configured for cloud-based or other remote processing, for example, including an electrical node set 538 upon which instances of informational data 315 are represented digitally as a corresponding voltage configuration 548. Transistor-based circuitry 509 may likewise include one or more instances of refinement modules 529 configured for cloud-based or other remote processing, for example, including an electrical node set 539 upon which informational data 315 is represented digitally as a corresponding voltage configuration 549.

In some variants methods hereof include obtaining a first plan (from or otherwise) on behalf of a first user and a net consequence of the first plan. The method also includes signaling a first evaluation whether or not the first plan has any recognized bias pattern, resulting in a negative determination. An artificial-intelligence-indicated (AII) bias pattern is thereafter signaled conditionally, partly based on the determination that the first plan has no recognized bias and partly based on the net consequence of the first plan being (at least partly) unfavorable. After updating a bias filter to include the All bias pattern the filter is applied to one or more other plans on behalf of the first user.

In some variants methods hereof include triggering a comparison of a plan on behalf of a first user against a bias filter based on the plan being misaligned with (one or more predictions comprising) a first estimated net consequence (ENC) of the plan and triggering a determination that the plan has one or more recognized biases. The method also includes saving the determination that the plan has the one or more recognized biases in non-transitory computer-readable storage media with an associated timestamp.

As used herein a favorable or other quantified “component” of a consequence can be directly opposed by an offsetting component of the same consequence. But a “net” component cannot, because a consequence is “net” by virtue of having taken all relevant opposing or aligned factors (if any) into account. As used herein a net consequence of one or more actions is “unfavorable” if their predicted or actual effect includes moving a relevant performance metric away from an explicit or other target even if other metrics comprising an actual net consequence 387 (ANC) are neutral or favorable. Various centrally or remotely implemented protocols are described herein, optionally implemented in one or more network 350, 450, 550 or having code downloaded to one or more client devices 800A-D in use by respective users 10A-D. As used herein an item of information is “pendent” if it is reliable (at least) insofar that it was obtained in regard to an actionable plan before that plan proved wise or foolish or otherwise prospectively in regard to a not-yet-known outcome of the plan. As used herein a bias “filter” comprises an aggregation of bias patterns or other recognizable criteria that can establish probative indications of bias 133 in one or more actions of a plan.

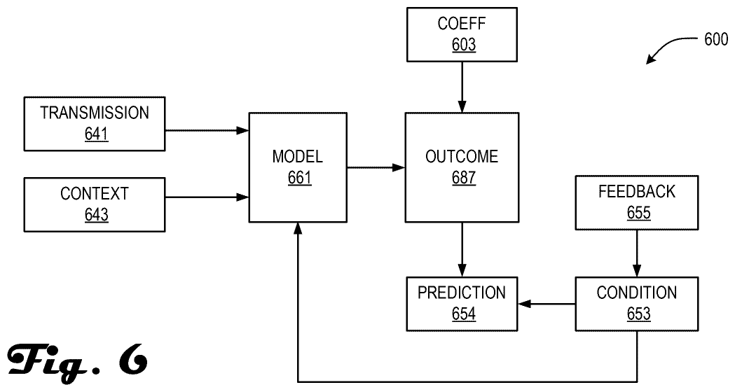

Referring now to FIG. 6 there is shown another block diagram 600, one that can overlap or exemplify that of FIG. 1 or 2. One or more transmissions 641 (e.g. defining user actions 516) are evaluated in their respective contexts 643 and applied through a model 661 to obtain one or more quantified outcomes 687 modified by respective coefficients 603 or other operators that allow a prediction 654 such as an ENC 387. For those predictions 654 that prove counterproductive or less successful, a mitigation 363 or other feedback 656 is applied to mitigate such outcomes 687 or make them more visible (e.g. by providing an attribution 453) or less consequential (or both). Toward that end one or more AI-updated conditions 653 are imposed that indicate when such intervention 255 or other feedback 655 is to be invoked.

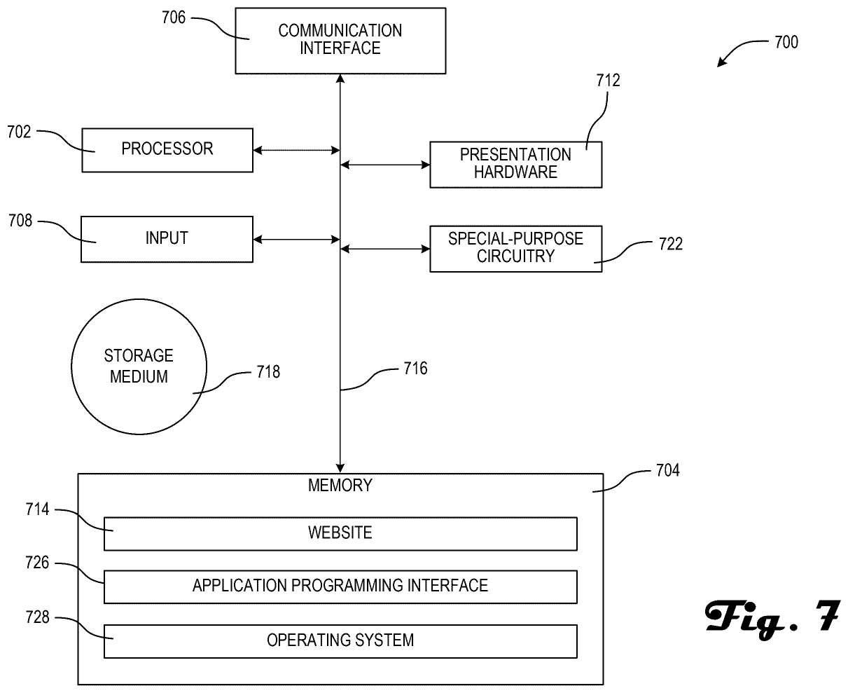

Referring now to FIG. 7, there is shown a server 700 in which one or more improved technologies may be incorporated. Server 700 may include one or more instances of processors 702, of memories 704, user inputs 708, and of (speakers or other) presentation hardware 712 all interconnected along with the network interface 706 via a bus 716. One or more network interfaces 706 allow server 700 to connect via the Internet or other networks 350, 450, 550). Memory 704 generally comprises a random access memory (“RAM”), a read only memory (“ROM”), and a permanent mass storage device, such as a disk drive.

Memory 704 may contain one or more instances of websites 714, of aggregation modules 726, of operating systems 728, or of data distillation modules that facilitate suggestions, confirmations, and other feedback 655 described herein. These and other software components may be loaded from (one or more) non-transitory computer readable storage media 718 into memory 704 of the server 700 using a drive mechanism (not shown) associated with non-transitory computer readable storage media 718, such as a floppy disc, tape, DVD/CD-ROM drive, flash card, memory card, or the like. In some embodiments, software or other digital components may be loaded via the network interface 706, rather than via a computer readable storage medium 718. Special-purpose circuitry 722 may, in some variants, include some or all of the event-sequencing logic described herein. In some embodiments server 700 may include many more components than those shown in FIG. 7, but it is not necessary that all conventional components of a server be shown in order to disclose an illustrative embodiment.

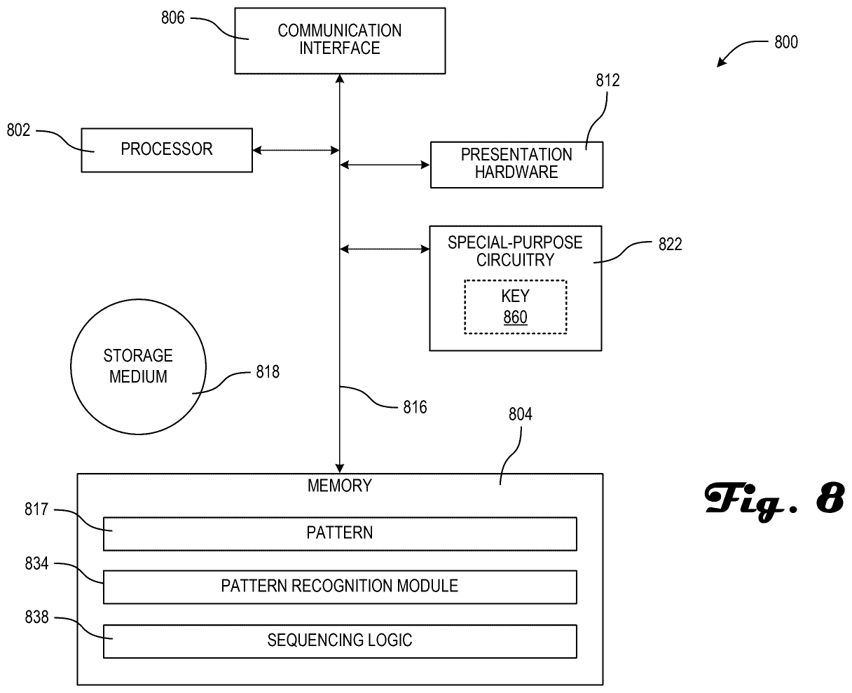

Referring now to FIG. 8, there is shown a client device 800 in which one or more improved technologies may be incorporated. Client device 800 may include one or more instances of processors 802, of memories 804, user inputs 808, and of (speakers or other) presentation hardware 812 all interconnected along with the network interface 806 via a bus 816. One or more network interfaces 806 allow device 800 to connect via the Internet or other networks 350, 450, 660). Memory 804 generally comprises a random-access memory (“RAM”), a read only memory (“ROM”), and a permanent mass storage device, such as a disk drive.

Memory 804 may contain one or more instances of premises 147 of patterns 817, of device-implemented pattern recognition modules 834, or of other event-sequencing logic 838 described herein. Such patterns may include threshold boundaries 142 or other criteria that specify where a trending determinant becomes a bias indication or contraindication, for example. When implemented in device-executable code, these and other components may be loaded from non-transitory computer readable storage media 818 into memory 804 of the client device 800 using a drive mechanism (not shown) associated with non-transitory computer readable storage medium 818, such as a floppy disc, tape, DVD/CD-ROM drive, flash card, memory card, or the like. In some embodiments, software or other digital components may be loaded via the network interface 806, rather than via a computer readable storage medium 818. Special-purpose circuitry 822 (implementing a private key 860 or other security feature, e.g.) may, in some variants, include some or all of the event-sequencing logic described herein. In some embodiments client device 800 may include many more components than those shown in FIG. 8, but it is not necessary that all conventional components of a mobile device be shown in order to disclose an illustrative embodiment.

As used herein a bias pattern is “based on economic theory” if it corresponds to (a behavioral finance definition of) an anchoring bias, a confirmation bias, a loss aversion, an overconfidence bias, an availability heuristic, an illusion of transparency, a messenger effect, a choice overload, a status quo bias, an omission bias, an illusion of control, a leveling and sharpening, a lag effect, a gambler's fallacy, a motivating uncertainty effect, a Pygmalion effect, a base rate fallacy, a zero risk bias, a disposition effect, a self-serving bias, a just-world hypothesis, an authority bias, a Google effect bias, an impact bias, a fundamental attribution error, a representativeness heuristic, an action bias, a naïve realism, a peak-end rule, an endowment effect, an ostrich effect, a bikeshedding bias, a hard-easy effect, an extrinsic incentive bias, an in-group bias, a Benjamin Franklin effect, a pessimism bias, a cashless effect, an illusory truth effect, a response bias, a noble edge effect, a spotlight effect, a telescoping effect, a primacy effect, a Maslow's Hammer bias, an observer expectancy effect, a false consensus effect, a social norms bias, a bundling bias, an identifiable victim effect, a bounded rationality, a suggestibility, a bye-now effect, an incentivization, a restraint bias, an overjustification effect, a hot hand fallacy, a normalcy bias, a distinction bias, a naïve allocation, a hyperbolic discounting, a regret aversion, a negativity bias, a commitment bias, a pluralistic ignorance, an attentional bias, an IKEA effect, a source confusion, a belief perseverance, an illusion of validity, a framing effect, an affect heuristic, a look-elsewhere effect, a heuristics, a hindsight bias, a levels of processing, an optimism bias, a salience bias, an empathy gap, a mental accounting, a planning fallacy, a less-is-better effect, a nostalgia effect, a projection bias, a functional fixedness, a bottom-dollar effect, an Einstellung effect, a serial position effect, a priming, a reactive devaluation, a recency effect, a mere exposure effect, a Dunning-Kruger effect, a category size bias, a survivorship bias, a halo effect, a declinism, a rosy retrospection, an illusion of explanatory depth, a sunk cost fallacy, a take-the-best heuristic, a Barnum effect, a decision fatigue, a decoy effect, a sexual overperception bias, an illusory correlation, an ambiguity effect, a spacing effect, a cognitive dissonance, a bandwagon effect, or a combination of these. Each of these theory-based biases 133 can be digitally encoded as a corresponding pattern 817 or filter 517 and thereby compared against and recognized in observable bias-manifesting actions 516 and plans 244 as described herein without any undue experimentation. By contrast newfound biases are not “based on economic theory” unless context dictates otherwise: e.g. by virtue of the theory being addressed in a peer-reviewed research paper or trade journal and thereafter expressed and used as a searchable behavioral pattern 817.

More generally a “theory” as used herein refers to a well-substantiated explanation of some aspect of the natural world that can incorporate laws, hypotheses, and facts. It does not extend to a mere guess or provisional inference gleaned from a newfound correlation.

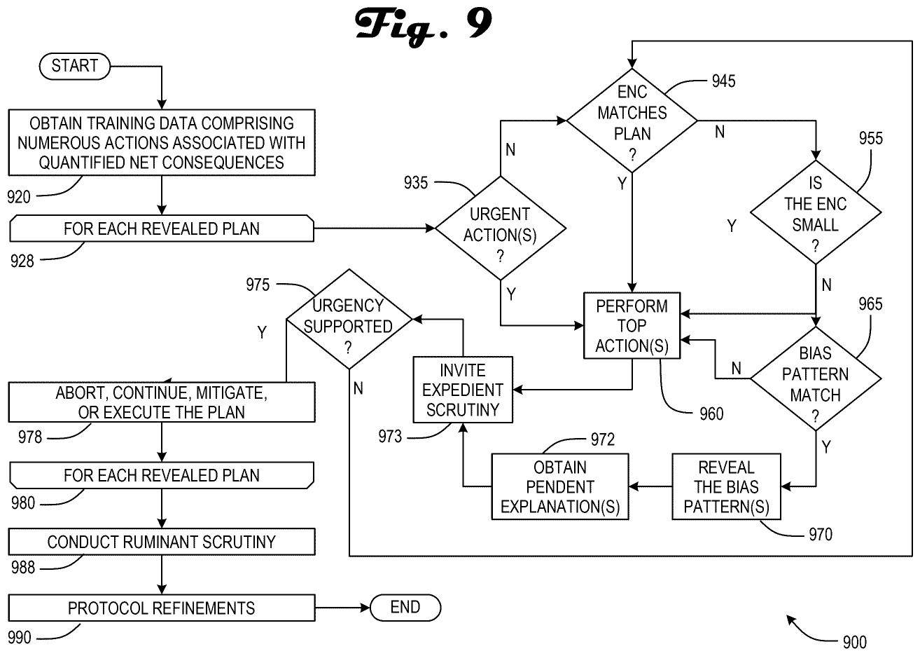

Referring now to FIG. 9, there is shown a flow 900 suitable for implementation as one or more routines executed or coordinated by one or more processors 702, 802 or other event-sequencing circuitry 709 described herein. As will be recognized by those having ordinary skill in the art, not all events of information management are illustrated in FIG. 9. Rather, for clarity, only those steps reasonably relevant to describing the bias response aspects of flow 900 are shown and described. These are exemplary embodiments and it will be understood that variations may be made without departing from the scope of the broader inventive concept set forth in clauses and claims below.

Following a start operation, flow 900 begins with an operation 920 depicting obtaining training data comprising numerous actions associated with quantified net consequences (e.g. several processors 702, 802 or aggregation modules 521 capturing records 316 depicting numerous actions 516 and contexts 143, 243 associated with quantified net consequences 387 of (policies 302 or other) plans 244 initiated by multiple users 10 having actions 516 each associated with a resulting consequence 387 used as training data 315 by or on behalf of a first user 10A). Control then passes to operation 930.

Operation 930 begins a loop executed for each revealed plan (e.g. several processors 702, 802 or a first control module 522 initiating a control loop handling protocol 449] on a first plan 244). Control passes (immediately or otherwise) to operation 935.

Operation 935 operates contingently, depending on whether or not a current plan includes any actions deemed urgent. For example if a first action 516 of the current plan 244 then control passes to operation 960 and otherwise control passes to operation 945.

Operation 945 also operates contingently, depending on whether or not an estimated net consequence (ENC) of a current plan is consistent with (or “matches”) the current plan. If the above-referenced training data 315 establishes a significant correlation 388 of actions 516 of the current plan 244 with one or more significant benefits 456, a predictive model 361, 661 that generates the first ENC 387 can determine that the ENC 387 of the current plan 244 is favorable. In that case the ENC 387 “matches” the current plan 244 control passes to operation 960. Otherwise control passes to operation 955.

Operation 955 likewise operates contingently, depending on whether or not an ENC of the current plan has a small magnitude relative to a standard currently in effect (e.g. a threshold or similar boundary 142 applicable to each of the component(s) 421 a user 10 has opted to monitor). If an ENC 387 of a user's currently revealed plan 244 is sufficiently small in magnitude (e.g. being smaller than a user-selected threshold that is 3-30% of a size of the ENC 387) then control passes to operation 960 and otherwise control passes to operation 965.

Operation 960 describes performing one or more top (priority) actions 516 of the current plan. Control passes to operation 973.

Operation 965 operates contingently, depending on whether or not the current plan exhibits a bias pattern that is currently being filtered (e.g. using a bias filter 517 having multiple bias patterns 817). In some variants most of such patterns 817 may initially be based on economic or psychological theory and may include boundary parameters 386 that trend so as to reduce a rate of unbiased decisions 145, 245 being misclassified as biased or to reduce a rate of biased decisions 145, 245 going unnoticed (or both) based on a ruminant scrutiny protocol 449G that includes a statistical aggregation of both of these error types 385. If a bias pattern match using a current filter 517 does not indicate that the current plan 244 exhibits a defined bias pattern 817 then control passes to operation 960 and otherwise control passes to operation 970.

Operation 970 describes revealing (definitions, attributions 453, or other salient properties of) the currently matched one or more bias patterns (e.g. selectively to a first and second user 10B 10A-B) in lieu of commencing not-urgent action(s) of the current plan. Control (immediately or otherwise) then passes to operation 972.

Operation 972 describes obtaining one or more pendent explanations for the one or more bias patterns as they apparently relate to the current plan of one or more users who were aware of or interested in a success or failure of the current plan (e.g. selectively to some users 10A-B and their supervisor who selected or authorized the current plan 244). This can occur, for example, in a context 143, 243 in which some such users 10A-B would otherwise only provide after-the-fact explanation 141 as logical support 311 for the current plan 244; in which a natural language processing machine learning model 361, 661 trained on a corpus of explanations 141 for various types 385 of actions 516 is used to enrich and evaluate the sufficiency of the user's pendent answers; in which such user input would allow for numerous incremental improvements to the bias filter 517; and in which a lack of such pendent interaction would otherwise delay or prevent improvements to the bias filter 517. Control passes to operation 973.

Operation 973 describes guiding or otherwise eliciting expedient scrutiny (e.g. by inviting one or more resource managers 210 or other authorized users 10 to confirm whether or not performing the top action(s) 516 resolved the urgency of the current plan). Control passes to operation 975.

Operation 975 operates contingently, depending on whether or not an urgent performance of one or more still-to-do components of the current plan 244 is deemed supported by a present context (e.g. as determined by an application of one or more automatic or other rules or principles defined via an expert system or other authorized entity). If so then control passes to operation 978 and otherwise control passes to operation 945.

Operation 978 describes aborting, continuing, mitigating, or executing the current plan 244 as appropriate to the operation sequence by which control passed previously. Control passes to operation 980.

Operation 980 completes the loop executed for each revealed plan and triggers another iteration upon a next revealed plan if one exists. After completing an iteration for a final revealed plan control passes to operation 988.

Operation 988 describes conducting ruminant scrutiny (e.g. invoking a scrutiny protocol 449G for people and tools acting, at least in part, on most or all of the ruminant determinants 101 shown in FIG. 1). Ruminant scrutiny may include automatically or otherwise analyzing a suggestion of adjusting operating parameters 386. Control passes to operation 990.

Operation 990 describes making protocol refinements (e.g. adjusting boundary parameters 386 or other aspects of decision protocols 449K in regard to what determinations 458 affect control flow like those of operations 935, 945, 955, 965, and 975). In some variants it may include revising one or more evaluation protocols 4490 relating to urgency determinations 458 like those of operations 935 and 975, to determining net consequences more comprehensively or efficiently, to discerning bias-like behavior that should not be filtered but explained as a paradigm shift, to omitting some determinations 458 like operation 955, to evaluating whether or not a plan is suited for reduced scrutiny, or other strategic adjustments 303 to protocols described herein. Control can terminate at an end operation.

Although various operational flows are described in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various system, method, article of manufacture, or other embodiments or aspects have been disclosed above, also, other combinations of embodiments or aspects will be apparent to those skilled in the art in view of the above disclosure. The various embodiments and aspects disclosed above are for purposes of illustration and are not intended to be limiting, with the true scope and spirit being indicated in the final claim set that follows.

In the numbered clauses below, first combinations of aspects and embodiments are articulated in a shorthand form such that (1) according to respective embodiments, for each instance in which a “component” or other such identifiers appear to be introduced (e.g., with “a” or “an,”) more than once in a given chain of clauses, such designations may either identify the same user or distinct entities; and (2) what might be called “dependent” clauses below may or may not incorporate, in respective embodiments, the features of “independent” clauses to which they refer or other features described above.

### CLAUSES

Clause 1. A computer-implemented bias response method comprising:
invoking first transistor-based circuitry (e.g. a decision and distillation module 523, 528 jointly) configured to calculate using one or more processors 702, 802 a first ENC 387 of a first plan 244 based on a machine learning module 525 trained using numerous records 316 of actions 516 and their corresponding ANCs 387;
invoking second transistor-based circuitry (e.g. a control and pattern recognition module 522, 834 jointly) configured to perform a data-driven comparison using the one or more processors 702, 802 of the first plan 244 on behalf of a first user 10A against a first bias filter 517 and thereby to trigger a first evaluation whether or not the first plan 244 has any recognized bias 133;
invoking third transistor-based circuitry (e.g. control, distillation, and pattern recognition modules 522, 528, 834 jointly) configured to obtain a first artificial-intelligence-indicated (All) bias pattern 817 conditionally, partly based on a first actual net consequence 387 of the first plan 244 being unfavorable and partly based on the first evaluation whether or not the first plan 244 has any recognized bias pattern 817 resulting in a determination 458 that the first plan 244 has no recognized bias 133;
invoking fourth transistor-based circuitry (e.g. control and refinement modules 522, 529 jointly) configured to obtain an updated bias filter 517 by adding the first All bias pattern 817 to the first bias filter 517;
invoking fifth transistor-based circuitry (e.g. control and pattern recognition modules 522, 834 jointly) configured to calculate a comparison of a second plan 244 on behalf of the first user 10A against the updated bias filter 517 and to trigger conditionally a determination 458 that the second plan 244 has one or more recognized biases 133; and invoking sixth transistor-based circuitry (e.g. an interface module 526) configured to save the determination 458 that the second plan 244 has the one or more recognized biases 133 in (one or more) non-transitory computer-readable storage media 718, 818.
Clause 2. The computer-implemented bias response method of any of the above clauses comprising:
invoking transistor-based circuitry (e.g. generative and refinement module 526, 529 jointly) configured to modify one or more parameters 386 of a predictive model 361, 661 used in generating at least the first ENC 387 by updating a weighting scheme for factors considered in an estimation protocol 449F of the predictive model 361, 661 wherein the first ANC 387 and the first ENC 387 both include a confidence level or other computed scalar evaluation as a component and wherein a second bias pattern 817 of the first bias filter 517 is not based on economic theory but upon a correlation 388 obtained via statistical regression and upon one or more protocol refinements confirmed iteratively via one or more ruminant scrutiny protocols 449G whereby the second bias pattern 817 became a guided-artificial-intelligence-derived second bias pattern 817 having a specific bias identifier 457 confirmed by or otherwise associated with the first user 10A.
Clause 3. The computer-implemented bias response method of any of the above clauses comprising:
the invoking the first transistor-based circuitry including receiving the first plan 244 via a first communication interface from or otherwise on behalf of the first user 10A as a component of calculating the first ENC 387 of the first plan 244.
Clause 4. The computer-implemented bias response method of any of the above clauses wherein the data-driven comparison of the first plan 244 against the first bias filter 517 is performed (at least partly) based on the first plan 244 being misaligned with the first ENC 387.
Clause 5. The computer-implemented bias response method of any of the above clauses wherein the first bias filter 517 includes a theory-based first bias pattern 817 and a second bias pattern 817 not based on economic theory but upon a correlation 388 of prior actions 516 with one or more (at least partly) unfavorable historical outcomes 687.
Clause 6. The computer-implemented bias response method of any of the above clauses comprising:
invoking transistor-based circuitry (e.g. generative module 527) configured to generate a speculative logical basis 113, 313 for the second plan 244 using machine learning based on an apparent or other mismatch between the second plan 244 and the second ENC 387 and partly based on no other logical basis 113, 313 yet being associated with the second plan 244;
invoking transistor-based circuitry (e.g. an instance of interface modules 526) configured to prompt the first user 10A to modify or accept the speculative logical basis 113, 313; and
invoking transistor-based circuitry (e.g. decision and response modules 523-524) configured to allow a completion of the second plan 244 only after the first user 10A has modified or accepted the speculative logical basis 113, 313.
Clause 7. The computer-implemented bias response method of any of the above clauses comprising:
saving both a first description of the first All bias pattern 817 and the determination 458 that the second plan 244 (apparently) has one or more recognized biases 133 in the non-transitory computer-readable storage media 718, 818 whereby the first All bias pattern 817 is thereafter distinguished on behalf of one or more other All bias patterns 817.
Clause 8. The computer-implemented bias response method of any of the above clauses comprising:
invoking transistor-based circuitry (e.g. distillation and pattern recognition modules 528, 834) configured to make the first All bias pattern 817 inclusive enough to recognize a future recurrence of the first plan 244 as a bias manifestation 364 wherein the first All bias pattern 817 is partly based on the first plan 244 having no other recognized bias pattern 817 and partly based on a discrepancy 382 between the first ANC 387 and the first ENC 387 being significant.
Clause 9. The computer-implemented bias response method of any of the above clauses comprising:
invoking transistor-based circuitry (e.g. control and interface modules 522, 834) configured to send via one or more network interfaces 706, 806 a prompt for a pendent explanation 141 of the second plan 244 having the one or more recognized biases 133 to the first user 10A or to a second user 10B; and invoking transistor-based circuitry configured to save in the non-transitory computer-readable storage media (1) the pendent explanation 141 of the second plan 244 having the one or more recognized biases 133 provided in response or (2) the prompt for the pendent explanation 141 wherein the explanation 141 is pendent at least insofar that it is not provided by anyone who has access to the first ANC 387 of the first plan 244.
Clause 10. The computer-implemented bias response method of any of the above clauses wherein at least one of the first ANC 387 or the first ENC 387 is unfavorable insofar that at least one scalar consequence component thereof is in direct opposition to one or more preferences 381 of the first user 10A.
Clause 11. The computer-implemented bias response method of any of the above clauses comprising:
invoking transistor-based circuitry configured to detect a discrepancy 382 between the first ENC 387 and a first ANC 387 based on one or more actual outcomes 687 associated with the first plan 244 over a time period exceeding one day after the first plan 244 is completed or otherwise resolved wherein the first ANC 387 describes one or more true events that were imperfectly predicted by the ENC 387.
Clause 12. The computer-implemented bias response method of any of the above clauses comprising:
invoking transistor-based circuitry configured to calculate using the one or more processors 702, 802 multiple bias patterns of the updated bias filter 517 against one or more actions 516 of a third plan 244 using a first recognition protocol;
invoking transistor-based circuitry configured to identify a match between the one or more actions 516 and an AI-provided, user-provided, or user-selected first custom bias identifier 457 validated or otherwise accepted by the first or second user 10B; invoking transistor-based circuitry configured to associate the first custom bias identifier 457 with a first prior behavior of the first user 10A and with a first general behavioral bias pattern 817 that is consistent with the first prior behavior of the first user 10A;
invoking transistor-based circuitry configured to refine the first general behavioral bias pattern 817 using a machine learning module 525 and an accuracy-based or confidence-based scoring protocol 449B to create a particular custom bias pattern 817 associated with the first custom bias identifier 457; and
invoking transistor-based circuitry configured to reveal the match between the third plan 244 and the first custom bias identifier 457 to the first user 10A based on a determination 458 that the particular custom bias pattern 817 matches at least one action 516 of the third plan 244.
Clause 13. The computer-implemented bias response method of any of the above clauses comprising:
invoking transistor-based circuitry configured to identify one or more suspect actions 516 in the second plan 244 that match a first evidence-based bias-indicative behavior pattern 817 repeatedly exhibited on prior occasions by the first user 10A, wherein the first evidence-based bias-indicative behavior pattern 817 is correlated or otherwise associated with a history of mostly unfavorable outcomes 687.
Clause 14. The computer-implemented bias response method of any of the above clauses comprising:
invoking transistor-based circuitry configured to implement a natural language processing machine learning model 361, 661 trained on a corpus of explanations 141 for various types 385 of actions 516;
invoking transistor-based circuitry configured to iteratively refine the logical basis 113, 313 through a series of interactions with the first user 10A, wherein each iteration includes using the natural language processing machine learning model 361, 661 to generate one or more follow-up questions or other prompts to elicit additional information or clarification regarding the logical basis 113, 313 and to analyze how the user responds; and
invoking transistor-based circuitry (e.g. (e.g. control, decision, and refinement modules 522, 523, 529 jointly) configured to determine, using the natural language processing machine learning model 361, 661, when the refined logical basis 113, 313 meets a predetermined threshold of clarity or completeness as a prerequisite to an adoption of the first plan 244 whereby a reliability of the refined logical basis 113, 313 is ensured (at least) by virtue of at least some pendent user input therein.
Clause 15. The computer-implemented bias response method of any of the above clauses comprising:
invoking transistor-based circuitry configured to monitor one or more actual outcomes 687 associated with the first plan 244 over a time period exceeding one day after the first plan 244 was completed or otherwise fully resolved; and
invoking transistor-based circuitry configured to adjust an estimation protocol 449F used to obtain a second ENC 387 based on a discrepancy 382 between the first ENC 387 and a first actual net consequence (ANC) based on the monitored one or more actual outcomes 687 by modifying one or more parameters 386 of an adaptive prediction protocol 449D used in the estimation protocol 449F (e.g. by updating a weighting scheme for factors considered in the estimation protocol 449F).
Clause 16. The computer-implemented bias response method of any of the above clauses comprising:
invoking transistor-based circuitry configured to monitor a first ANC 387 associated with the one or more actions 516 over a time period exceeding one day after the one or more actions 516 were completed or otherwise resolved;
invoking transistor-based circuitry configured to calculate using the one or more processors 702, 802 the first ANC 387 with the first ENC 387 and thereby detect a first discrepancy 382;
invoking transistor-based circuitry configured to adjust an estimation protocol 449F used to obtain the first ENC 387 based on the discrepancy 382 between the calculated ANC 387 and the first ENC 387 by modifying one or more feature selection protocols 449P used in the estimation protocol 449F or by newly incorporating a type 385 of data 315 that correlates significantly with ANC data 315 into the estimation protocol 449F; and
invoking transistor-based circuitry configured to save a resulting adjusted estimation protocol 449F in the non-transitory computer-readable storage media 718, 818 so as to allow subsequent use in estimating ENCs 387 with future actions 516.
Clause 17. The computer-implemented bias response method of any of the above clauses comprising:
basing the second bias pattern 817 upon a correlation 388 of (one or more components of) prior actions 516 with unfavorable outcomes 687 obtained via statistical regression and upon one or more protocol refinements confirmed iteratively via one or more ruminant scrutiny protocols 449G whereby the second bias pattern 817 became a guided-artificial-intelligence-derived second bias pattern 817 having a specific bias identifier 457 confirmed by or otherwise associated with the first user 10A;
transmitting a notification of a match between the first plan 244 and the specific bias identifier 457 conditionally by virtue of an instance of the guided-artificial-intelligence-derived second bias pattern 817 having been detected in the first plan 244;
suggesting a refinement of the guided-artificial-intelligence-derived second bias pattern 817 conditionally upon a mitigation 363 or other first plan 244 modification by someone who received the notification of the match between the first plan 244 and the specific bias identifier 457.
Clause 18. The computer-implemented bias response method of any of the above clauses comprising:
invoking transistor-based circuitry (e.g. control and recognition modules 522, 834) configured to cause a comparison of the several bias patterns that correspond to a naïve allocation and one or more other theory-based biases 133 against one or more actions 516 of the first plan 244 on behalf of the first user 10A according to a first recognition protocol; and
invoking transistor-based circuitry configured to reveal to the first user 10A a first match between the one or more actions 516 of the first plan 244 and a first custom bias identifier 457 conditionally, partly based on a prior occasion in which the first user 10A associated a generic bias pattern 817 with one or more prior behaviors and with the first custom bias identifier 457 and partly based on the generic bias pattern 817 having been improved with a pattern definition refinement protocol 449M into an improved custom bias pattern 817 associated with the first custom bias identifier 457 that matches the one or more actions 516 wherein the pattern definition refinement protocol 449M has been implemented by a machine learning module 525 using an accuracy-based or confidence-based scoring protocol.
Clause 19. The computer-implemented bias response method of any of the above clauses comprising:
invoking transistor-based circuitry (e.g. control and interface modules 522, 526) configured to receive a third plan 244 on behalf of the first user 10A;
invoking transistor-based circuitry configured to determine on behalf of the first user 10A that a first action 516 of the third plan 244 is deemed urgent;
invoking transistor-based circuitry configured to initiate a performance of the third plan 244 in real time as a conditional response to at least one of the third plan 244 signaling that the first action 516 of the third plan 244 is urgent or the first ENC 387 being smaller than a first threshold value;
invoking transistor-based circuitry (e.g. control and interface modules 522, 526 jointly) configured to report the third plan 244 (at least) to the second user 10B before the third plan 244 is complete and thereafter to receive input (from or otherwise) on behalf of the second user 10B signaling a suspension of the third plan 244; and
invoking transistor-based circuitry configured to suspend the third plan 244 partly based on the first action 516 of the third plan 244 having been deemed urgent and partly based on input from the second user 10B signaling a suspension of the third plan 244.
Clause 20. The computer-implemented bias response method of any of the above clauses comprising:
invoking transistor-based circuitry configured to process at least some of the historical data 315 of actions 516 and their corresponding ANC 387s as training data 315 using one or more machine learning modules 525 to select a prediction protocol;
invoking transistor-based circuitry configured to apply the prediction protocol 449D to one or more actions 516 of the first plan 244 to estimate the first ENC 387 of the first plan 244;
invoking transistor-based circuitry configured to update the prediction protocol 449D based on a first actual net consequence (ANC) that corresponds to the first ENC 387;
invoking transistor-based circuitry configured to store the updated prediction protocol 449D in a durable repository for subsequent use in estimating one or more ENCs 387 for one or more corresponding actions 516;
invoking transistor-based circuitry (e.g. another generative module 527) configured to generate one or more risk scores 383 for the one or more ENCs 387 based on one or more commonalities between the one or more corresponding actions 516 and respective components in the training data 315; and
invoking transistor-based circuitry configured to obtain and display a confidence-indicative determination 458 in association with the second ENC 387 based on the one or more risk scores 383.
Clause 21. The computer-implemented bias response method of any of the above clauses comprising:
invoking transistor-based circuitry (e.g. one or more generative modules 527) configured to generate, using a natural language generation protocol, a notification message 314 explaining a logical basis 113, 313 of one or more actions 516 of the second plan 244 in a manner tailored to a role and expertise of a second user 10B in response to an indication that no logical basis 113, 313 for the second plan 244 has yet been deemed sufficient by the second user 10B;
invoking transistor-based circuitry configured to use a machine learning-based scheduling protocol 449L to configure and deliver the notification message 314 explaining the logical basis 113, 313 of one or more actions 516 of the second plan 244 to the second user 10B so as to maximize a likelihood of the second user 10B responding favorably; and
invoking transistor-based circuitry (e.g. generative and distillation modules 527-528) configured to track—using a machine learning-based feedback analysis model 361, 661—a response of the second user 10B to the notification message 314 and use this information to refine the natural language generation protocol 449N or to refine the machine learning-based scheduling protocol 449L.
Clause 22. The computer-implemented bias response method of any of the above clauses comprising:
invoking transistor-based circuitry (e.g. a control and interface module 522, 526 jointly) configured to obtain (an expression 115 of) the first plan 244 from or otherwise on behalf of a first user 10A and to compute using one or more processors 702, 802 the estimated net consequence (ENC) of the first plan 244 based on a machine learning model 361, 661 trained using historical data 315 of actions 516 and their corresponding actual net consequences (ANCs).
Clause 23. The computer-implemented bias response method of any of the above clauses comprising:
invoking transistor-based circuitry (e.g. a control and distillation module 522, 526 jointly) configured to compute using one or more processors 702, 802 the estimated net consequence (ENC) of the first plan 244 based on historical data 315 of actions 516 and their corresponding actual net consequences (ANCs).
Clause 24. The computer-implemented bias response method of any of the above clauses comprising:
invoking transistor-based circuitry (e.g. an aggregation or distillation module 521, 528 configured to calculate using one or more processors 702, 802 a first ENC of the first plan 244 based on a machine learning model 361, 661 trained using historical data 315 of actions 516 and their corresponding actual net consequences (ANCs).
Clause 25. The computer-implemented bias response method of any of the above clauses comprising:
determining that the first plan 244 is “misaligned” with the first ENC 387 (at least) insofar that an unfavorable outcome 687 is deemed likely if the first plan 244 is implemented.
Clause 26. The computer-implemented bias response method of any of the above clauses comprising:
determining that the first plan 244 is “misaligned” with the first ENC 387 (at least) insofar that an unfavorable outcome 687 is deemed likely (at least) by two or more other users 10 if the first plan 244 is implemented.
Clause 27. The computer-implemented bias response method of any of the above clauses comprising:
invoking transistor-based circuitry (e.g. control and pattern recognition modules 522, 834) configured to perform a data 315-driven comparison of the first plan 244 from the first user 10A against a first bias filter 517 based on the first plan 244 being (apparently or otherwise) misaligned with the first ENC 387.
Clause 28. The computer-implemented bias response method of any of the above clauses comprising:
triggering a first evaluation whether or not the first plan 244 has any recognized bias.
Clause 29. The computer-implemented bias response method of any of the above clauses comprising:
performing a first evaluation whether or not the first plan 244 has any recognized bias by applying a filter 517 defining all of the recognized biases 133 to (a digital manifestation 364 of) the first plan 244.
Clause 30. The computer-implemented bias response method of any of the above clauses comprising:
invoking transistor-based circuitry configured to establish a first artificial-intelligence-indicated (AII) bias pattern 817 conditionally, partly based on a first ANC 387 of the first plan 244 being unfavorable and partly based on the first evaluation whether or not the first plan 244 has any recognized bias pattern 817 resulting in a determination 458 that the first plan 244 has no recognized bias 133;
invoking transistor-based circuitry configured to obtain an updated bias filter 517 by adding the first All bias patttern 817 to the first bias filter 517;
invoking transistor-based circuitry (e.g. control and pattern recognition modules 522, 834) configured to calculate a comparison of a second plan 244 from the first user 10A against the updated bias filter 517 based on the second plan 244 being misaligned with a second ENC 387 of the second plan 244 and to trigger conditionally a determination 458 that the second plan 244 has one or more recognized biases 133; and
invoking transistor-based circuitry configured to save the determination 458 that the second plan 244 has one or more recognized biases 133 in non-transitory computer-readable storage media.
Clause 31. The computer-implemented bias response method of any of the above clauses comprising:
invoking transistor-based circuitry configured to establish a first artificial-intelligence-indicated (All) bias pattern 817 conditionally, partly based on a first ANC 387 of the first plan 244 being unfavorable and partly based on the first evaluation whether or not the first plan 244 has any recognized bias pattern 817 resulting in a determination 458 that the first plan 244 has no recognized bias 133;
invoking transistor-based circuitry configured to obtain an updated bias filter 517 by adding the first All bias pattern 817 to the first bias filter 517; and
invoking transistor-based circuitry (e.g. control and pattern recognition modules 522, 834) configured to calculate a comparison of a second plan 244 from the first user 10A against the updated bias filter 517 based on the second plan 244 being misaligned with a second ENC 387 of the second plan 244 and to trigger conditionally a determination 458 that the second plan 244 has one or more recognized biases 133.
Clause 32. The computer-implemented bias response method of any of the above clauses comprising:
invoking transistor-based circuitry configured to establish a first artificial-intelligence-indicated (AII) bias pattern 817 conditionally, partly based on a first ANC 387 of the first plan 244 being unfavorable and partly based on the first evaluation whether or not the first plan 244 has any recognized bias pattern 817 resulting in a determination 458 that the first plan 244 has no recognized bias 133; and invoking transistor-based circuitry configured to obtain an updated bias filter 517 by adding the first All bias pattern 817 to the first bias filter 517.
Clause 33. The computer-implemented bias response method of any of the above clauses comprising:
invoking transistor-based circuitry configured to establish a first artificial-intelligence-indicated (AII) bias pattern 817 conditionally, (at least partly) based on a first ANC 387 of the first plan 244 being unfavorable.
Clause 34. The computer-implemented bias response method of any of the above clauses comprising:
invoking transistor-based circuitry configured to establish a first artificial-intelligence-indicated (All) bias pattern 817 conditionally, (at least partly) based on the first evaluation whether or not the first plan 244 has any recognized bias pattern 817 resulting in a determination 458 that the first plan 244 has no recognized bias.
Clause 35. The computer-implemented bias response method of any of the above clauses wherein at least two predicted increases are combined by one or more processors 702, 802 as components of the estimated net consequence
Clause 36. The computer-implemented bias response method of any of the above clauses wherein at least two predicted decreases are combined (e.g. pursuant to prediction and arithmetic protocols 449D-E) as components of the estimated net consequence.
Clause 37. The computer-implemented bias response method of any of the above clauses wherein at least one predicted increase and one predicted decrease are combined (e.g. pursuant to prediction and arithmetic protocols 449D-E) as offsetting components of the estimated net consequence.
Clause 38. The computer-implemented bias response method of any of the above clauses wherein at least one quantification of risk is included by one or more processors 702, 802 as an unfavorable component of the estimated net consequence.
Clause 39. The computer-implemented bias response method of any of the above clauses wherein at least one penalty or cost is included (e.g. pursuant to prediction and arithmetic protocols 449D-E) as an unfavorable component of the estimated net consequence.
Clause 40. The computer-implemented bias response method of any of the above clauses wherein at least one bounty or donation is included by one or more processors 702, 802 as a favorable component of the estimated net consequence.
Clause 41. The computer-implemented bias response method of any of the above clauses comprising:
invoking transistor-based circuitry (e.g. generative module 527) configured to generate a speculative logical basis 113, 313 for a second plan 244 using machine learning partly based on an apparent or other mismatch between the second plan 244 and the second ENC 387 and partly based on no other logical basis 113, 313 yet being associated with the second plan 244;
invoking transistor-based circuitry configured to prompt the first user 10A to modify or accept the speculative logical basis 113, 313; and
invoking transistor-based circuitry configured to allow a completion of the second plan 244 only after the first user 10A has modified or accepted the speculative logical basis 113, 313.
Clause 42. The computer-implemented bias response method of any of the above clauses comprising:
invoking transistor-based circuitry (e.g. one or more generative modules 527) configured to generate a speculative logical basis 113, 313 for a second plan 244 using machine learning partly based on an apparent or other mismatch between the second plan 244 and the second ENC 387 and partly based on no other logical basis 113, 313 yet being associated with the second plan 244; and
invoking transistor-based circuitry configured to prompt the first user 10A to modify or accept the speculative logical basis 113, 313.
Clause 43. The computer-implemented bias response method of any of the above clauses comprising:
invoking transistor-based circuitry (e.g. a generative module 527) configured to generate a speculative logical basis 113, 313 for a second plan 244 using machine learning partly based on an apparent or other mismatch between the second plan 244 and the second ENC 387 and partly based on no other logical basis 113, 313 yet being associated with the second plan 244.
Clause 44. The computer-implemented bias response method of any of the above clauses comprising:
invoking transistor-based circuitry (e.g. generative module 527) configured to generate a speculative logical basis 113, 313 for a second plan 244 using machine learning (at least partly) based on an apparent or other mismatch between the second plan 244 and the second ENC 387.
Clause 45. The computer-implemented bias response method of any of the above clauses comprising:
invoking transistor-based circuitry (e.g. a generative module 527) configured to generate a speculative logical basis 113, 313 for a second plan 244 using machine learning based on no other logical basis 113, 313 yet being associated with the second plan 244.
Clause 46. The computer-implemented bias response method of any of the above clauses comprising:
saving both a first description of the first All bias pattern 817 and the determination 458 that the second plan 244 has one or more recognized biases 133 in the non-transitory computer-readable storage media 718, 818 whereby the first All bias pattern 817 is thereafter (immediately or otherwise) distinguished from one or more other All bias patterns 817.
Clause 47. The computer-implemented bias response method of any of the above clauses comprising:
invoking transistor-based circuitry (e.g. a generative or refinement module 527, 529) configured to make the first All bias pattern inclusive enough to recognize a future recurrence of the first plan 244 as a bias manifestation 364 wherein the first All bias pattern is partly based on the first plan 244 having no other recognized bias pattern and partly based on a discrepancy 382 between the first ANC 387 and the first ENC 387 being significant.
Clause 48. The computer-implemented bias response method of any of the above clauses comprising:
invoking transistor-based circuitry configured to send via one or more network interfaces 706, 806 a prompt for a pendent explanation 141 of the second plan 244 having the one or more recognized biases 133 to the first user 10A or to a second user 10B; and invoking transistor-based circuitry configured to save in the non-transitory computer-readable storage media (1) the pendent explanation 141 of the second plan 244 having the one or more recognized biases 133 provided in response or (2) the prompt for the pendent explanation 141 (or both) wherein the explanation 141 is pendent at least insofar that it is not provided by anyone who has access to the first ANC 387 of the first plan 244.
Clause 49. The computer-implemented bias response method of any of the above clauses wherein at least one of the first ANC 387 or the first ENC 387 is unfavorable insofar that at least one scalar consequence component thereof is in direct opposition to one or more preferences 381 of the first user 10A.
Clause 50. The computer-implemented bias response method of any of the above clauses comprising:
invoking transistor-based circuitry configured to detect a discrepancy 382 between the first ENC 387 and a first ANC 387 based on one or more actual outcomes 687 associated with the first plan 244 over a time period exceeding one day after the first plan 244 is completed or otherwise resolved wherein the first ANC 387 describes one or more true events that were imperfectly predicted by the ENC 387.
Clause 51. The computer-implemented bias response method of any of the above clauses comprising:
invoking transistor-based circuitry configured to calculate using the one or more processors 702, 802 multiple bias patterns 817 of the updated bias filter 517 against one or more actions 516 of a third plan 244 using a first recognition protocol;
invoking transistor-based circuitry configured to identify a match between the one or more actions 516 and an AI-provided, user-provided, or user-selected first custom bias identifier 457 validated or otherwise accepted by the first or second user 10B;
invoking transistor-based circuitry configured to associate the first custom bias identifier 457 with a first prior behavior of the first user 10A and with a first general behavioral bias pattern that is consistent with the first prior behavior of the first user 10A;
invoking transistor-based circuitry configured to refine the first general behavioral bias pattern using a machine learning module 525 and an accuracy-based or confidence-based scoring protocol 449B to create a particular custom bias pattern associated with the first custom bias identifier 457; and
invoking transistor-based circuitry configured to reveal the match between the third plan 244 and the first custom bias identifier 457 to the first user 10A based on a determination 458 that the particular custom bias pattern matches at least one action 516 of the third plan 244.
Clause 52. The computer-implemented bias response method of any of the above clauses comprising:
invoking transistor-based circuitry configured to identify one or more suspect actions 516 in the second plan 244 that match a first evidence-based bias-indicative behavior pattern repeatedly exhibited on prior occasions by the first user 10A, wherein the first evidence-based bias-indicative behavior pattern is correlated or otherwise associated with a history of mostly unfavorable outcomes 687.
Clause 53. The computer-implemented bias response method of any of the above clauses comprising:
invoking transistor-based circuitry configured to implement a natural language processing machine learning model 361, 661 trained on a corpus of explanations 141 for various types 385 of actions 516;
invoking transistor-based circuitry (e.g. generative and distillation modules 527-528) configured to iteratively refine the logical basis 113, 313 through a series of interactions with the first user 10A, wherein each iteration includes using the natural language processing machine learning model 361, 661 to generate one or more follow-up questions or other prompts to elicit additional information or clarification regarding the logical basis 113, 313 and to analyze how the user responds; and
invoking transistor-based circuitry (e.g. control, decision, and refinement modules 522, 523, 529 jointly) configured to determine—using the natural language processing machine learning model 361, 661—when the refined logical basis 113, 313 meets a predetermined threshold of clarity or completeness (or both) as a prerequisite to an adoption of the first plan 244.
Clause 54. The computer-implemented bias response method of any of the above clauses comprising:
invoking transistor-based circuitry configured to monitor one or more actual outcomes 687 associated with the first plan 244 over a time period exceeding one day after the first plan 244 was completed or otherwise fully resolved; and
invoking transistor-based circuitry (e.g. control and refinement modules 522, 529 jointly) configured to adjust an estimation protocol 449F used to obtain a second ENC 387 based on a discrepancy 382 between the first ENC 387 and a first actual net consequence (ANC) based on the monitored one or more actual outcomes 687 by modifying one or more parameters 386 of a prediction protocol 449D used in the estimation protocol 449F or by updating a weighting scheme for factors considered in the estimation protocol 449F (or both).
Clause 55. The computer-implemented bias response method of any of the above clauses comprising:
invoking transistor-based circuitry configured to monitor a first actual net consequence (ANC) associated with the one or more actions 516 over a time period exceeding one hour after the one or more actions 516 were completed or otherwise resolved;
invoking transistor-based circuitry configured to calculate using the one or more processors 702, 802 the first ANC 387 with the first ENC 387 and thereby detect a first discrepancy 382;
invoking transistor-based circuitry to adjust an estimation protocol 449F used to obtain the first ENC 387 based on the discrepancy 382 between the calculated ANC 387 and the first ENC 387 by modifying one or more feature selection protocols 449P used in the estimation protocol 449F or by newly incorporating a type 385 of data 315 that correlates significantly (e.g. having a scalar contextual parameter 386 with a correlation coefficient larger than 0.6) with ANC data 315 into the estimation protocol 449F (or both); and
invoking transistor-based circuitry configured to save a resulting adjusted estimation protocol 449F in the non-transitory computer-readable storage media 718, 818 so as to allow subsequent use in estimating ENCs 387 with future actions 516.
Clause 56. The computer-implemented bias response method of any of the above clauses comprising:
invoking transistor-based circuitry configured to evaluate multiple bias patterns via a first collaboration protocol 449H that includes:
establishing several theory-based bias patterns among the multiple bias patterns including a theory-based first bias pattern 817 and a second bias pattern 817 not (primarily) based on economic theory but (primarily) upon a correlation 388 of prior actions 516 with unfavorable outcomes 687 obtained via statistical regression and upon one or more protocol refinements confirmed iteratively via one or more ruminant scrutiny protocols 449G whereby the second bias pattern 817 became a guided-artificial-intelligence-derived second bias pattern 817 having a specific bias identifier 457 confirmed by, customized for, matched to, or otherwise associated with the first user 10A;
transmitting a notification of a match between the first plan 244 and the specific bias identifier 457 conditionally by virtue of an instance of the guided-artificial-intelligence-derived second bias pattern 817 having been detected in the first plan 244;
suggesting a refinement of the guided-artificial-intelligence-derived second bias pattern 817 conditionally upon a mitigation 363 or other first plan modification by someone who received the notification of the match between the first plan 244 and the specific bias identifier 457.
Clause 57. The computer-implemented bias response method of any of the above clauses comprising:
invoking transistor-based circuitry (e.g. control and pattern recognition modules 522, 834) configured to cause a comparison of the several bias patterns that correspond to a naïve allocation and one or more other theory-based biases 133 against one or more actions 516 of the first plan 244 from the first user 10A according to a first recognition protocol; and
invoking transistor-based circuitry configured to reveal to the first user 10A a first match between the one or more actions 516 of the first plan 244 and a first custom bias identifier 457 conditionally, partly based on a prior occasion in which the first user 10A associated a generic bias pattern 817 with one or more prior behaviors and with the first custom bias identifier 457 and partly based on the generic bias pattern 817 having been improved with a pattern definition refinement protocol 449M into an improved custom bias pattern 817 associated with the first custom bias identifier 457 that matches the one or more actions 516 wherein the pattern definition refinement protocol 449M has been implemented by a machine learning module 525 using an accuracy-based or confidence-based scoring protocol 449B (or both).
Clause 58. The computer-implemented bias response method of any of the above clauses comprising:
invoking transistor-based circuitry (e.g. an interface module 526) configured to receive input associated with a third plan 244 from the first user 10A;
invoking transistor-based circuitry configured to determine from the input that a first action 516 of the third plan 244 is deemed urgent;
invoking transistor-based circuitry configured to initiate a performance of the third plan 244 in real time as a conditional response to at least one of the third plan 244 signaling that the first action 516 of the third plan 244 is urgent or the first ENC 387 being smaller than a first threshold value;
invoking transistor-based circuitry configured to report the third plan 244 to the second user 10B before the third plan 244 is complete and thereafter (immediately or otherwise) to receive input from a second user 10B signaling a suspension of the third plan 244; and
invoking transistor-based circuitry configured to suspend the third plan 244 partly based on the first action 516 of the third plan 244 having been deemed urgent and partly based on input from the second user 10B signaling a suspension of the third plan 244.
Clause 59. The computer-implemented bias response method of any of the above clauses comprising:
invoking transistor-based circuitry configured to process at least some historical data of actions 516 and their corresponding ANC 387s as training data 315 using one or more machine learning modules 525 to select a prediction protocol;
invoking transistor-based circuitry configured to apply the prediction protocol 449D to one or more actions 516 of the first plan 244 to estimate the first ENC 387 of the first plan 244;
invoking transistor-based circuitry configured to update the prediction protocol 449D based on a first actual net consequence (ANC) that corresponds to the first ENC 387;
invoking transistor-based circuitry configured to store the updated prediction protocol 449D in a durable repository for subsequent use in estimating one or more ENCs 387 for one or more corresponding actions 516;
invoking transistor-based circuitry configured to generate one or more risk scores 383 for the one or more ENCs 387 based on one or more commonalities between the one or more corresponding actions 516 and respective components in the training data 315; and
invoking transistor-based circuitry configured to obtain and display a confidence-indicative determination 458 in association with the second ENC 387 based on the one or more risk scores 383.
Clause 60. The computer-implemented bias response method of any of the above clauses comprising:
invoking transistor-based circuitry (e.g. a generative module 527) configured to generate, using a natural language generation protocol, a notification message 314 explaining a logical basis 113, 313 of one or more actions 516 of the second plan 244 in a manner tailored to a role and expertise of a second user 10B in response to an indication that no logical basis 113, 313 for the second plan 244 has yet been deemed sufficient by the second user 10B;
invoking transistor-based circuitry (e.g. machine learning and module 52x) configured to use a machine learning-based scheduling protocol 449L to configure and deliver the notification message 314 to the second user 10B so as to maximize a likelihood of timely response; and
invoking transistor-based circuitry (e.g. interface and refinement modules 526, 529 jointly) configured to track, using a machine learning-based feedback analysis model 361, 661, a response of the second user 10B to the notification message 314 and use this information to refine the natural language generation protocol 449N or to refine the machine learning-based scheduling protocol 449L (or both).
Clause 61. The computer-implemented bias response method of any of the above clauses wherein the first ANC 387 and the first ENC 387 both include a resource determination 458 458 or other scalar size component.
Clause 62. The computer-implemented bias response method of any of the above clauses wherein the first ANC 387 and the first ENC 387 both include a follower or vote count or other scalar demographic component.
Clause 63. The computer-implemented bias response method of any of the above clauses wherein the first ANC 387 and the first ENC 387 both include a body weight or other measurable health-indicative scalar component.
Clause 64. The computer-implemented bias response method of any of the above clauses wherein the first ANC 387 and the first ENC 387 both include a temperature or other scalar measurement as a component.
Clause 65. The computer-implemented bias response method of any of the above clauses comprising:
basing the first bias pattern 817 on economic theory by configuring the first bias pattern 817 according to a definition of an anchoring bias, a confirmation bias, a loss aversion, an overconfidence bias, an availability heuristic, an illusion of transparency, a messenger effect, a choice overload, a status quo bias, an omission bias, an illusion of control, a leveling and sharpening, a lag effect, a gambler's fallacy, a motivating uncertainty effect, a Pygmalion effect, a base rate fallacy, a zero risk bias, a disposition effect, a self-serving bias, a just-world hypothesis, an authority bias, a Google effect, an impact bias, a fundamental attribution error, a representativeness heuristic, an action bias, a naïve realism, a peak-end rule, an endowment effect, an ostrich effect, a bikeshedding, a hard-easy effect, an extrinsic incentive bias, an in-group bias, a Benjamin Franklin effect, a pessimism bias, a cashless effect, an illusory truth effect, a response bias, a noble edge effect, a spotlight effect, a telescoping effect, a primacy effect, a law of the instrument, an observer expectancy effect, a false consensus effect, a social norms, a bundling bias, an identifiable victim effect, a bounded rationality, a suggestibility, a bye-now effect, an incentivization, a restraint bias, an overjustification effect, a hot hand fallacy, a normalcy bias, a distinction bias, a naïve allocation, a hyperbolic discounting, a regret aversion, a negativity bias, a commitment bias, a pluralistic ignorance, an attentional bias, an IKEA effect, a source confusion, a belief perseverance, an illusion of validity, a framing effect, an affect heuristic, a look-elsewhere effect, a heuristics, a hindsight bias, a levels of processing, an optimism bias, a salience bias, an empathy gap, a mental accounting, a planning fallacy, a less-is-better effect, a nostalgia effect, a projection bias, or a combination of these.
Clause 66. The computer-implemented bias response method of any of the above clauses comprising:
basing the first bias pattern 817 on economic theory by configuring the first bias pattern 817 according to a definition of an anchoring bias, a confirmation bias, a loss aversion, an overconfidence bias, an availability heuristic, or a combination of these.
Clause 67. The computer-implemented bias response method of any of the above clauses comprising:
basing the first bias pattern 817 on economic theory by configuring the first bias pattern 817 according to a definition of an illusion of transparency, a messenger effect, a choice overload, a status quo bias, an omission bias, an illusion of control, a leveling and sharpening, a lag effect, a gambler's fallacy, a motivating uncertainty effect, a Pygmalion effect, a base rate fallacy, a zero risk bias, a disposition effect, a self-serving bias, a just-world hypothesis, an authority bias, a Google effect, an impact bias, a fundamental attribution error, a representativeness heuristic, an action bias, a naïve realism, a peak-end rule, an endowment effect, an ostrich effect, a bikeshedding, a hard-easy effect, an extrinsic incentive bias, an in-group bias, a Benjamin Franklin effect, a pessimism bias, a cashless effect, an illusory truth effect, a response bias, a noble edge effect, a spotlight effect, a telescoping effect, a primacy effect, a law of the instrument, an observer expectancy effect, a false consensus effect, a social norms, a bundling bias, an identifiable victim effect, a bounded rationality, a suggestibility, a bye-now effect, an incentivization, a restraint bias, an overjustification effect, a hot hand fallacy, a normalcy bias, a distinction bias, a naïve allocation, a hyperbolic discounting, a regret aversion, a negativity bias, a commitment bias, a pluralistic ignorance, an attentional bias, an IKEA effect, a source confusion, a belief perseverance, an illusion of validity, a framing effect, an affect heuristic, a look-elsewhere effect, a heuristics, a hindsight bias, a levels of processing, an optimism bias, a salience bias, an empathy gap, a mental accounting, a planning fallacy, a less-is-better effect, a nostalgia effect, a projection bias, or a combination of these.
Clause 68. The computer-implemented bias response method of any of the above clauses comprising:
basing the first bias pattern 817 on economic theory by configuring the first bias pattern 817 (at least partly) according to a definition of a functional fixedness, a bottom-dollar effect, an Einstellung Effect, a serial position effect, a priming, a reactive devaluation, a recency effect, a mere exposure effect, a Dunning-Kruger Effect, a category size bias, a survivorship bias, a halo effect, a declinism, a rosy retrospection, an illusion of explanatory depth, a sunk cost fallacy, a take-the-best heuristic, a Barnum effect, a decision fatigue, a decoy effect, a sexual overperception bias, an illusory correlation, an ambiguity effect, a spacing effect, a cognitive dissonance, a bandwagon effect, or a combination of these.
Clause 69. A computer-implemented bias response system 300, 400, 500 comprising:
the transistor-based circuitry (e.g. functional modules 521-529) of any one of the above method clauses.
Clause 70. The computer-implemented bias response system of any of the above clauses wherein one or more device-executable code segments correspond to and define each of the protocols and wherein each of the protocols is performed by invoking its corresponding device-executable code segment(s) via one or more processors 702, 802.
Clause 71. A computer-implemented bias response system 300, 400, 500 comprising:
transistor-based circuitry (e.g. decision, distillation, and pattern recognition modules 523, 528, 834 jointly) configured to calculate a comparison of a first plan 244 from or otherwise on behalf of a first user 10A against a bias filter 517 based on the first plan 244 being misaligned with (one or more predictions comprising) a first estimated net consequence (ENC) of the first plan 244 and to trigger a determination 458 that the first plan 244 has one or more recognized biases 133; and
transistor-based circuitry (e.g. an interface module 526) configured to save the determination 458 that the first plan 244 has the one or more recognized biases 133 in non-transitory computer-readable storage media.
Clause 72. A computer-implemented bias response system 300, 400, 500 comprising:
first transistor-based circuitry (e.g. a decision and distillation module 523, 528 jointly) configured to calculate using one or more processors 702, 802 a first ENC 387 of a first plan 244 based on a machine learning module 525 trained using numerous records 316 of actions 516 and their corresponding ANCs 387;
second transistor-based circuitry (e.g. a control and pattern recognition module 522, 834 jointly) configured to perform a data-driven comparison using the one or more processors 702, 802 of the first plan 244 on behalf of a first user 10A against a first bias filter 517 and thereby to trigger a first evaluation whether or not the first plan 244 has any recognized bias 133;
third transistor-based circuitry (e.g. control, distillation, and pattern recognition modules 522, 528, 834 jointly) configured to obtain a first artificial-intelligence-indicated (All) bias pattern 817 conditionally, partly based on a first actual net consequence 387 of the first plan 244 being unfavorable and partly based on the first evaluation whether or not the first plan 244 has any recognized bias pattern 817 resulting in a determination 458 that the first plan 244 has no recognized bias 133;
fourth transistor-based circuitry (e.g. control and refinement modules 522, 529 jointly) configured to obtain an updated bias filter 517 by adding the first All bias pattern 817 to the first bias filter 517;
fifth transistor-based circuitry (e.g. control and pattern recognition modules 522, 834 jointly) configured to calculate a comparison of a second plan 244 on behalf of the first user 10A against the updated bias filter 517 and to trigger conditionally a determination 458 that the second plan 244 has one or more recognized biases 133; and
sixth transistor-based circuitry (e.g. an interface module 526) configured to save the determination 458 that the second plan 244 has one or more recognized biases 133 in non-transitory computer-readable storage media.
Clause 73. The system of any of the above system clauses configured to include most or all numbered features of system 300 as shown in FIG. 3.
Clause 74. The system of any of the above system clauses configured to include most or all numbered features of system 400 as shown in FIG. 4.
Clause 75. The computing system of any of the above system clauses wherein an instance of control and interface modules 522, 528 thereof (is included and) resides on a single integrated circuit chip.
Clause 76. The computing system of any of the above system clauses wherein an instance of control and interface modules 522, 528 thereof resides in a single apparatus.
Clause 77. The computing system of any of the above system clauses wherein an instance of control and interface modules 522, 528 thereof (is included and) resides in one or more cloud-resident servers 700.
Clause 78. The computing system of any of the above system clauses and configured to perform a method of at least a corresponding one of the above method clauses.

With respect to the numbered claims expressed below, those skilled in the art will appreciate that recited operations therein may generally be performed in any order. Also, although various operational flows are presented in sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Terms like “responsive to,” “related to,” or other such transitive, relational, or other connections do not generally exclude such variants, unless context dictates otherwise. Furthermore each claim below is intended to be given its least-restrictive interpretation that is reasonable to one skilled in the art.

1. A computer-implemented bias response method comprising:
invoking first transistor-based circuitry configured to calculate using one or more processors a first estimated net consequence (ENC) of a first plan based on a machine learning module trained using numerous records of actions and their corresponding actual net consequences (ANCs), the invoking the first transistor-based circuitry including receiving the first plan via a first communication interface from or otherwise on behalf of the first user as a component of calculating the first ENC of the first plan;
invoking second transistor-based circuitry configured to perform a data-driven comparison using the one or more processors of the first plan on behalf of a first user against a first bias filter and thereby to trigger a first evaluation whether or not the first plan has any recognized bias wherein the data-driven comparison of the first plan against the first bias filter is performed based on the first plan being misaligned with the first ENC and wherein the first bias filter includes a first bias pattern;
invoking third transistor-based circuitry configured to obtain a first artificial-intelligence-indicated (AII) bias pattern conditionally, partly based on a first actual net consequence of the first plan being unfavorable and partly based on the first evaluation whether or not the first plan has any recognized bias pattern resulting in a determination that the first plan has no recognized bias;
invoking fourth transistor-based circuitry configured to obtain an updated bias filter by adding the first AII bias pattern to the first bias filter;
invoking fifth transistor-based circuitry configured to calculate a comparison of a second plan on behalf of the first user against the updated bias filter and to trigger conditionally a determination that the second plan has one or more recognized biases; and
invoking sixth transistor-based circuitry configured to save the determination that the second plan has one or more recognized biases in non-transitory computer-readable storage media.

2. The computer-implemented bias response method of claim 1 comprising:
basing the first bias pattern on economic theory by configuring the first bias pattern according to a definition of an anchoring bias, a confirmation bias, a loss aversion, an overconfidence bias, an availability heuristic, an illusion of transparency, a messenger effect, a choice overload, a status quo bias, an omission bias, an illusion of control, a leveling and sharpening, a lag effect, a gambler's fallacy, a motivating uncertainty effect, a Pygmalion effect, a base rate fallacy, a zero risk bias, a disposition effect, a self-serving bias, a just-world hypothesis, an authority bias, a Google effect, an impact bias, a fundamental attribution error, a representativeness heuristic, an action bias, a naïve realism, a peak-end rule, an endowment effect, an ostrich effect, a bikeshedding, a hard-easy effect, an extrinsic incentive bias, an in-group bias, a Benjamin Franklin effect, a pessimism bias, a cashless effect, an illusory truth effect, a response bias, a noble edge effect, a spotlight effect, a telescoping effect, a primacy effect, a law of the instrument, an observer expectancy effect, a false consensus effect, a social norms, a bundling bias, an identifiable victim effect, a bounded rationality, a suggestibility, a bye-now effect, an incentivization, a restraint bias, an overjustification effect, a hot hand fallacy, a normalcy bias, a distinction bias, a naïve allocation, a hyperbolic discounting, a regret aversion, a negativity bias, a commitment bias, a pluralistic ignorance, an attentional bias, an IKEA effect, a source confusion, a belief perseverance, an illusion of validity, a framing effect, an affect heuristic, a look-elsewhere effect, a heuristics, a hindsight bias, a levels of processing, an optimism bias, a salience bias, an empathy gap, a mental accounting, a planning fallacy, a less-is-better effect, a nostalgia effect, a projection bias, or a combination of these.

3. The computer-implemented bias response method of claim 1 comprising:
modifying one or more parameters of a predictive model used in generating at least the first ENC by updating a weighting scheme for factors considered in an estimation protocol of the predictive model wherein the first ANC and the first ENC both include a confidence level or other computed scalar evaluation as a component and wherein a second bias pattern of the first bias filter is not based on economic theory but upon a correlation obtained via statistical regression and upon one or more protocol refinements confirmed iteratively via one or more ruminant scrutiny protocols whereby the second bias pattern became a guided-artificial-intelligence-derived second bias pattern having a specific bias identifier confirmed by or otherwise associated with the first user.

4. The computer-implemented bias response method of claim 1 comprising:
invoking transistor-based circuitry configured to generate a speculative logical basis for the second plan using machine learning based on an apparent or other mismatch between the second plan and the second ENC and partly based on no other logical basis yet being associated with the second plan;
invoking transistor-based circuitry configured to prompt the first user to modify or accept the speculative logical basis; and
invoking transistor-based circuitry configured to allow a completion of the second plan only after the first user has modified or accepted the speculative logical basis.

5. The computer-implemented bias response method of claim 1 comprising:
saving both a first description of the first AII bias pattern and the determination that the second plan has one or more recognized biases in the non-transitory computer-readable storage media whereby the first AII bias pattern is thereafter distinguished on behalf of one or more other AII bias patterns.

6. The computer-implemented bias response method of claim 1 comprising:
invoking transistor-based circuitry configured to make the first AII bias pattern inclusive enough to recognize a future recurrence of the first plan as a bias manifestation wherein the first AII bias pattern is partly based on the first plan having no other recognized bias pattern and partly based on a discrepancy between the first ANC and the first ENC being larger than a threshold.

7. The computer-implemented bias response method of claim 1 comprising:
invoking transistor-based circuitry configured to send via one or more network interfaces a prompt for a pendent explanation of the second plan having the one or more recognized biases to the first user or to a second user; and
invoking transistor-based circuitry configured to save in the non-transitory computer-readable storage media (1) the pendent explanation of the second plan having the one or more recognized biases provided in response or (2) the prompt for the pendent explanation wherein the explanation is pendent at least insofar that it is not provided by anyone who has access to the first ANC of the first plan.

8. The computer-implemented bias response method of claim 1 wherein at least one of the first ANC or the first ENC is unfavorable insofar that at least one scalar consequence component thereof is in direct opposition to one or more preferences of the first user.

9. The computer-implemented bias response method of claim 1 comprising:
invoking transistor-based circuitry configured to detect a discrepancy between the first ENC and a first ANC based on one or more actual outcomes associated with the first plan over a time period exceeding one day after the first plan is completed or otherwise resolved wherein the first ANC describes one or more true events that were imperfectly predicted by the ENC.

10. The computer-implemented bias response method of claim 1 comprising:
invoking transistor-based circuitry configured to calculate using the one or more processors multiple bias patterns of the updated bias filter against one or more actions of a third plan using a first recognition protocol;
invoking transistor-based circuitry configured to identify a match between the one or more actions and an AI-provided, user-provided, or user-selected first custom bias identifier validated or otherwise accepted by the first or second user;
invoking transistor-based circuitry configured to associate the first custom bias identifier with a first prior behavior of the first user and with a first general behavioral bias pattern that is consistent with the first prior behavior of the first user;
invoking transistor-based circuitry configured to refine the first general behavioral bias pattern using a machine learning module and an accuracy-based or confidence-based scoring protocol to create a particular custom bias pattern associated with the first custom bias identifier; and
invoking transistor-based circuitry configured to reveal the match between the third plan and the first custom bias identifier to the first user based on a determination that the particular custom bias pattern matches at least one action of the third plan.

11. The computer-implemented bias response method of claim 1 comprising:
invoking transistor-based circuitry configured to identify one or more suspect actions in the second plan that match a first evidence-based bias-indicative behavior pattern repeatedly exhibited on prior occasions by the first user, wherein the first evidence-based bias-indicative behavior pattern is correlated or otherwise associated with a history of mostly unfavorable outcomes.

12. The computer-implemented bias response method of claim 1 comprising:
invoking transistor-based circuitry configured to implement a natural language processing machine learning model trained on a corpus of explanations for various types of actions;
invoking transistor-based circuitry configured to iteratively refine the logical basis through a series of interactions with the first user, wherein each iteration includes using the natural language processing machine learning model to generate one or more follow-up questions or other prompts to elicit additional information or clarification regarding the logical basis and to analyze how the user responds; and
invoking transistor-based circuitry configured to determine, using the natural language processing machine learning model, when the refined logical basis meets a predetermined threshold of clarity or completeness as a prerequisite to an adoption of the first plan whereby a reliability of the refined logical basis is ensured by virtue of at least some pendent user input therein.

13. The computer-implemented bias response method of claim 1 comprising:
invoking transistor-based circuitry configured to monitor one or more actual outcomes associated with the first plan over a time period exceeding one day after the first plan was completed or otherwise fully resolved; and
invoking transistor-based circuitry configured to adjust an estimation protocol used to obtain a second ENC based on a discrepancy between the first ENC and a first actual net consequence (ANC) based on the monitored one or more actual outcomes by modifying one or more parameters of an adaptive prediction protocol used in the estimation protocol.

14. The computer-implemented bias response method of claim 1 comprising:
invoking transistor-based circuitry configured to monitor a first actual net consequence (ANC) associated with the one or more actions over a time period exceeding one day after the one or more actions were completed or otherwise resolved;
invoking transistor-based circuitry configured to calculate using the one or more processors the first ANC with the first ENC and thereby detect a first discrepancy;
invoking transistor-based circuitry configured to adjust an estimation protocol used to obtain the first ENC based on the discrepancy between the calculated ANC and the first ENC by modifying one or more feature selection protocols used in the estimation protocol or by newly incorporating a type of data that correlates significantly with ANC data into the estimation protocol; and
invoking transistor-based circuitry configured to save a resulting adjusted estimation protocol in the non-transitory computer-readable storage media so as to allow subsequent use in estimating ENCs with future actions.

15. The computer-implemented bias response method of claim 1 comprising:
basing the second bias pattern upon a correlation of prior actions with unfavorable outcomes obtained via statistical regression and upon one or more protocol refinements confirmed iteratively via one or more ruminant scrutiny protocols whereby the second bias pattern became a guided-artificial-intelligence-derived second bias pattern having a specific bias identifier confirmed by or otherwise associated with the first user;
transmitting a notification of a match between the first plan and the specific bias identifier conditionally by virtue of an instance of the guided-artificial-intelligence-derived second bias pattern having been detected in the first plan;
suggesting a refinement of the guided-artificial-intelligence-derived second bias pattern conditionally upon a mitigation or other first plan modification by someone who received the notification of the match between the first plan and the specific bias identifier.

16. The computer-implemented bias response method of claim 1 comprising:
invoking transistor-based circuitry configured to cause a comparison of the several bias patterns that include a naïve allocation and one or more other theory-based biases against one or more actions of the first plan on behalf of the first user according to a first recognition protocol; and
invoking transistor-based circuitry configured to reveal to the first user a first match between the one or more actions of the first plan and a first custom bias identifier conditionally, partly based on a prior occasion in which the first user associated a generic bias pattern with one or more prior behaviors and with the first custom bias identifier and partly based on the generic bias pattern having been improved with a pattern definition refinement protocol into an improved custom bias pattern associated with the first custom bias identifier that matches the one or more actions wherein the pattern definition refinement protocol has been implemented by a machine learning module using an accuracy-based or confidence-based scoring protocol.

17. The computer-implemented bias response method of claim 1 comprising:
invoking transistor-based circuitry configured to receive input from a first user associated with a third plan on behalf of the first user;
invoking transistor-based circuitry configured to determine on behalf of the first user that a first action of the third plan is deemed urgent;
invoking transistor-based circuitry configured to initiate a performance of the third plan in real time as a conditional response to at least one of the third plan signaling that the first action of the third plan is urgent or the first ENC being smaller than a first threshold value;
invoking transistor-based circuitry configured to report the third plan to the second user before the third plan is complete and thereafter to receive input from a second user signaling a suspension of the third plan; and
invoking transistor-based circuitry configured to suspend the third plan partly based on the first action of the third plan having been deemed urgent and partly based on input from the second user signaling a suspension of the third plan.

18. The computer-implemented bias response method of claim 1 comprising:
invoking transistor-based circuitry configured to process at least some of the historical data of actions and their corresponding ANCs as training data using one or more machine learning modules to select an adaptive prediction protocol that reduces a size or frequency of discrepancies over numerous iterations;
invoking transistor-based circuitry configured to apply the prediction protocol to one or more actions of the first plan to estimate the first ENC of the first plan;
invoking transistor-based circuitry configured to update the prediction protocol based on a first actual net consequence (ANC) that corresponds to the first ENC;
invoking transistor-based circuitry configured to store the updated prediction protocol in a durable repository for subsequent use in estimating one or more ENCs for one or more corresponding actions;
invoking transistor-based circuitry configured to generate one or more risk scores for the one or more ENCs based on one or more commonalities between the one or more corresponding actions and respective components in the training data; and
invoking transistor-based circuitry configured to obtain and display a confidence-indicative determination in association with the second ENC based on the one or more risk scores.

19. The computer-implemented bias response method of claim 1 comprising:
invoking transistor-based circuitry configured to generate, using a natural language generation protocol, a notification message explaining a logical basis of one or more actions of the second plan in a manner tailored to a role and expertise of a second user in response to an indication that no logical basis for the second plan has yet been deemed sufficient by the second user;
invoking transistor-based circuitry configured to use a machine learning-based scheduling protocol to configure and deliver the notification message explaining the logical basis of one or more actions of the second plan to the second user so as to maximize a likelihood the second user responding favorably; and
invoking transistor-based circuitry configured to track, using a machine learning-based feedback analysis model, a response of the second user to the notification message and use this information to refine the natural language generation protocol or to refine the machine learning-based scheduling protocol.

20. A computer-implemented bias response method comprising:
invoking first transistor-based circuitry configured to calculate using one or more processors a first estimated net consequence (ENC) of a first plan based on a machine learning module trained using numerous records of actions and their corresponding actual net consequences (ANCs);
invoking second transistor-based circuitry configured to perform a data-driven comparison using the one or more processors of the first plan on behalf of a first user against a first bias filter and thereby to trigger a first evaluation whether or not the first plan has any recognized bias;
invoking third transistor-based circuitry configured to obtain a first artificial-intelligence-indicated (AII) bias pattern conditionally, partly based on a first actual net consequence of the first plan being unfavorable and partly based on the first evaluation whether or not the first plan has any recognized bias pattern resulting in a determination that the first plan has no recognized bias;
invoking fourth transistor-based circuitry configured to obtain an updated bias filter by adding the first AII bias pattern to the first bias filter;
invoking fifth transistor-based circuitry configured to calculate a comparison of a second plan on behalf of the first user against the updated bias filter and to trigger conditionally a determination that the second plan has one or more recognized biases; and
invoking sixth transistor-based circuitry configured to save the determination that the second plan has one or more recognized biases in non-transitory computer-readable storage media.

21. The computer-implemented bias response method of claim 20 comprising:
the invoking the first transistor-based circuitry including receiving the first plan via a first communication interface from or otherwise on behalf of the first user as a component of calculating the first ENC of the first plan wherein the data-driven comparison of the first plan against the first bias filter is performed based on the first plan being misaligned with the first ENC and wherein the first bias filter includes a theory-based first bias pattern and a second bias pattern not based on economic theory but upon a correlation of prior actions with one or more unfavorable outcomes.

22. A computer-implemented bias response computer program product comprising:
one or more tangible, nonvolatile storage media; and
machine instructions borne on the one or more tangible, nonvolatile storage media which, when running on one or more computer systems, cause the one or more computer systems to perform the method of claim 20.

23. A computer-implemented bias response system comprising:
first transistor-based circuitry configured to calculate using one or more processors a first estimated net consequence (ENC) of a first plan based on a machine learning module trained using numerous records of actions and their corresponding actual net consequences (ANCs);
second transistor-based circuitry configured to perform a data-driven comparison using the one or more processors of the first plan on behalf of a first user against a first bias filter and thereby to trigger a first evaluation whether or not the first plan has any recognized bias;
third transistor-based circuitry configured to obtain a first artificial-intelligence-indicated (AII) bias pattern conditionally, partly based on a first actual net consequence of the first plan being unfavorable and partly based on the first evaluation whether or not the first plan has any recognized bias pattern resulting in a determination that the first plan has no recognized bias;
fourth transistor-based circuitry configured to obtain an updated bias filter by adding the first AII bias pattern to the first bias filter;
fifth transistor-based circuitry configured to calculate a comparison of a second plan on behalf of the first user against the updated bias filter and to trigger conditionally a determination that the second plan has one or more recognized biases; and
sixth transistor-based circuitry configured to save the determination that the second plan has one or more recognized biases in non-transitory computer-readable storage media.
